(19) United States
(12) Patent Application Publication
(10) Pub. No.: US 2026/0289069 A1
(43) Pub. Date: Sep. 24, 2026

(54) SYSTEM

(71) Applicant: SoftBank Group Corp., Tokyo (JP)

(72) Inventor: Kei ONO, Tokyo (JP)

(73) Assignee: SoftBank Group Corp., Tokyo (JP)

(21) Appl. No.: 19/567,000

(22) Filed: Mar. 14, 2026

(30) Foreign Application Priority Data
Mar. 19, 2025 (JP) 2025-045281

(51) Int. Cl. G06F 40/137; G06F 40/134; G06F 40/211; G06F 40/284; G10L 15/26; H04L 51/224

(52) U.S. Cl. CPC G06F 40/137; G06F 40/134; G06F 40/211; G06F 40/284; G10L 15/26; H04L 51/224

(57) ABSTRACT

A system includes a processor that is configured to acquire meeting recording data and convert audio data included in the meeting recording data into text data, generate a prompt for instructing a generative artificial intelligence model to extract meeting topics, decisions, and action items from the text data, input the generated prompt into the generative artificial intelligence model, receive extracted information from the generative artificial intelligence model, summarize the extracted information, and identify links to related materials based on the extracted information.

### CROSS-REFERENCE TO RELATED APPLICATION

This application is based on and claims priority under 35 USC 119 from Japanese Patent Application No. 2025-045281 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, online conferencing systems such as web conferences and video conferences have been widely adopted in business and academic environments. These meetings are frequently recorded in the form of audio and video data, and the recorded data is used for subsequent review, information sharing, and documentation. However, manual processing of such recordings presents several problems.

First, a user often needs to listen to or watch the entire recording in order to identify important topics, decisions, and action items discussed during the meeting. This manual review is time-consuming and inefficient, particularly for long meetings or a large number of meetings. Second, preparation of accurate minutes that clearly capture the meeting topics, decisions, and action items requires substantial human effort and skill, and the quality of the minutes may vary depending on the person preparing them. Third, related materials such as slide decks, documents, and external resources are often scattered across different systems, and it is difficult to automatically link the extracted information in the minutes to such related materials. As a result, users must manually search for and correlate the meeting content with the corresponding documents.

Furthermore, while generative artificial intelligence models have recently become capable of advanced language processing, there is no sufficient mechanism in existing systems to effectively generate prompts tailored to specific meeting processing tasks, such as extraction of topics, decisions, and action items, automatic minutes creation, automatic transmission of communications, and search of video segments by time. Without appropriate prompt generation and orchestration, the potential of generative artificial intelligence models cannot be fully utilized, and automation remains limited.

Accordingly, there is a need for a system that can automatically acquire meeting recording data, convert audio data into text data, generate suitable prompts for generative artificial intelligence models, and thereby automatically extract meeting topics, decisions, and action items, summarize the extracted information, confirm links to related materials, generate minutes, transmit communications, and perform searches for specific video time segments. The present invention has been made in view of the above circumstances.

### SUMMARY

In order to solve the foregoing problems, according to one aspect of the present invention, there is provided a system comprising a processor, wherein the processor is configured to acquire meeting recording data and convert audio data included in the meeting recording data into text data, generate a prompt for instructing a generative artificial intelligence model to extract meeting topics, decisions, and action items from the text data, input the generated prompt into the generative artificial intelligence model, receive extracted information from the generative artificial intelligence model, summarize the extracted information, and identify links to related materials based on the extracted information. By automatically generating the prompt suitable for the extraction task and using the generative artificial intelligence model, the system reduces manual effort required to review the recording and to extract important information, and enables efficient generation of a structured summary that includes meeting topics, decisions, and action items along with links to related materials.

According to another aspect of the present invention, the processor is further configured to analyze the meeting recording data, generate a prompt for instructing the generative artificial intelligence model to automatically perform minutes creation and transmission of communications based on the analyzed meeting recording data, and perform the minutes creation and the transmission of the communications using the generative artificial intelligence model. In this manner, the system can automatically format the extracted information into minutes, generate appropriate communication content such as emails or notifications, and transmit the communication to participants or other stakeholders, thereby significantly reducing the burden on the user for preparing and distributing minutes and follow-up communications.

According to still another aspect of the present invention, the processor is further configured to analyze content of the meeting, generate a prompt for instructing the generative artificial intelligence model to perform a search by specifying a video time segment within the meeting recording data, and perform the search for the specified video time segment using the generative artificial intelligence model. By associating the textual content with corresponding video time segments and by leveraging the generative artificial intelligence model with appropriate prompts, the system enables a user to search for specific portions of the meeting recording, such as segments containing particular topics, decisions, or action items, and to directly access the relevant video time segments without having to manually scan the entire recording.

Through the above-described configuration, the system according to the present invention can efficiently process meeting recording data by converting audio to text, automatically generating prompts tailored to meeting-related tasks, and utilizing a generative artificial intelligence model to extract, summarize, and link information, to generate and transmit minutes and communications, and to perform searches for specified video time segments. Consequently, the invention addresses the problems of time-consuming manual review, inconsistent minutes quality, and difficulty in correlating meeting content with related materials, and provides an integrated solution for automated meeting analysis and utilization.

The term “meeting recording data” refers to data representing audio and/or video captured during a meeting session, including but not limited to web conferences, video conferences, and teleconferences.

The term “audio data” refers to data representing sound contained in the meeting recording data, including speech of participants and other audible signals recorded during the meeting. The term “text data” refers to character-based data obtained by converting the audio data into a textual representation, including transcripts and recognized speech content.

The term “generative artificial intelligence model” refers to a machine learning model configured to generate or transform natural language or other content in response to input data, including but not limited to large language models and similar generative models. The term “prompt” refers to information provided as input to the generative artificial intelligence model, the information including instructions, conditions, context, and/or example data that cause the generative artificial intelligence model to perform a specific processing task.

The term “meeting topics” refers to subject matters or themes discussed during the meeting, identified from the text data as distinct items of discussion.

The term “decisions” refers to conclusions, agreements, approvals, or determinations reached by participants during the meeting, as identified from the text data.

The term “action items” refers to tasks or activities that are to be performed after the meeting, the tasks or activities being identified from the text data and optionally associated with responsible persons and deadlines.

The term “extracted information” refers to information obtained from the text data by the generative artificial intelligence model in response to the prompt, including at least the meeting topics, decisions, and action items.

The term “summarize” refers to processing that generates a condensed representation of the extracted information, the condensed representation including essential points of the meeting topics, decisions, and action items.

The term “links to related materials” refers to references, such as URLs or file paths, that identify documents, slides, web pages, or other external resources associated with the meeting topics, decisions, or action items.

The term “minutes creation” refers to generating a structured document or data set that records at least part of the meeting topics, decisions, and action items in a form suitable for distribution or archival.

The term “communications” refers to messages transmitted to participants or other recipients, the messages including at least part of the minutes or other information derived from the meeting recording data, and being transmitted by means such as email, messaging systems, or notification services.

The term “video time segment” refers to a portion of the meeting recording data specified by a start time and optionally an end time within the full duration of the recording.

The term “search by specifying a video time segment” refers to processing that identifies and accesses one or more portions of the meeting recording data based on time information, such as a start time, end time, or time range within the recording.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

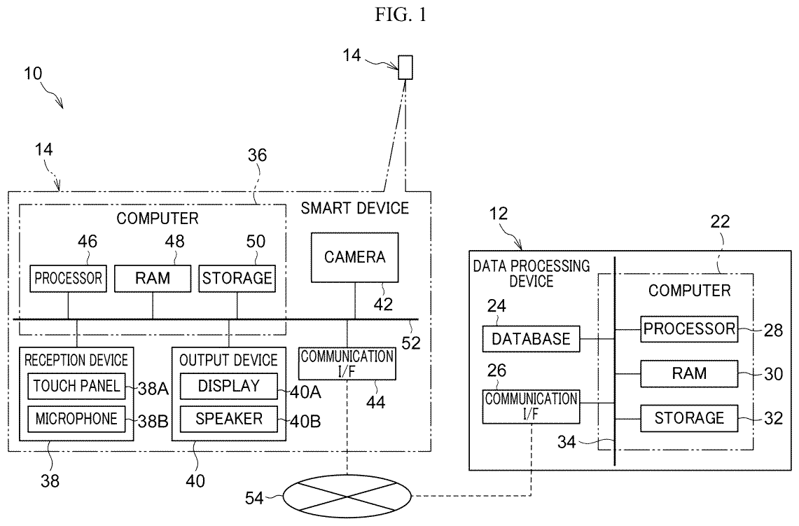

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

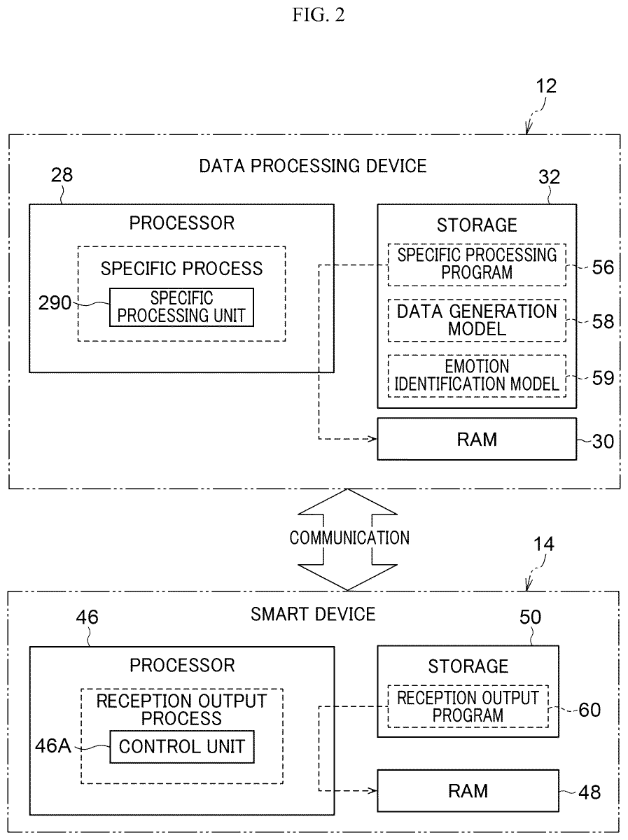

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for handling online meeting recordings typically perform only basic storage and playback of audiovisual data, leaving downstream processing such as transcription, minute generation, extraction of decisions and action items, and distribution of results to human operators or separate, loosely coupled tools. In such arrangements, multiple independent software components must be orchestrated manually or via ad hoc scripts, including recording retrieval, speech recognition, natural language analysis, and notification delivery. This fragmented architecture results in several technical problems, including high latency from meeting completion to availability of usable information, redundant data transfers between components, inefficient use of computational resources, and increased risk of failures at integration points.

Moreover, conventional natural language processing workflows often treat generative AI models as stand-alone utilities that are invoked with static, hand-crafted prompt sentences. These workflows do not tightly integrate prompt construction, model invocation, and post-processing logic into a single coordinated data processing pipeline anchored to the original time-coded recording data. As a result, it is difficult to maintain a consistent mapping between unstructured transcript text, structured meeting metadata (topics, decisions, action items), and the underlying video time ranges. This lack of consistent mapping makes it technically cumbersome to support efficient search and direct time-range playback of specific meeting segments on user terminals.

Further, existing systems typically do not provide an integrated mechanism by which a processor automatically generates machine-readable structured data, minutes documents, and participant notifications from meeting recordings, using a unified control flow over external recognition services, generative AI models, and communication services. Instead, human operators must perform intermediate steps, such as editing transcripts, manually extracting key items, and composing and sending emails. This leads to increased processor idle time, repetitive transfer of large data objects across networks, and non-deterministic processing paths that hinder optimization and scalability.

Accordingly, there is a need for an improved computer-implemented system that enhances the functioning of a server and associated storage and communication subsystems by: (i) automatically orchestrating retrieval of meeting recording data, audio extraction, speech recognition, and generative AI processing under control of a single processor; (ii) dynamically generating prompt sentences and structured inputs for a generative AI model based on stored transcript data; (iii) maintaining explicit associations among recording time information, utterance-level text segments, structured extraction information, and link information for materials shared during the meeting; and (iv) automatically generating and transmitting notification information, including minutes and action item lists, and enabling efficient search and time-range-based playback on user terminals. By addressing these issues at the system architecture and data-flow level, overall computer system performance, reliability, and usability in handling online meeting content can be significantly improved.

The specific processing by the specific processing unit 290 of the data processing device 12 in Example 1 is realized by the following means.

The present invention provides a server comprising a processor configured to acquire, based on meeting identification information, meeting recording data from an external storage device via a communication network, extract an audio signal from the acquired recording data, transmit the audio signal to a speech recognition processing apparatus or an external speech recognition service, and store text data obtained as a result of speech recognition processing on the audio signal; to generate, based on the text data, a prompt sentence for causing a generative AI model implemented by a machine learning processing apparatus or an external machine learning service to extract meeting topics, decisions, and action items, input to the generative AI model input data including the prompt sentence and the text data, and store, as structured data, extraction information output from the generative AI model; to generate, based on at least one of the text data and the extraction information, a prompt sentence for causing the generative AI model to generate summary information of an entire meeting, and store the summary information in association with link information indicating identification information or location information corresponding to documents or materials shared during the meeting; to manage the link information in association with at least one of the meeting recording data and minutes information, and store in association time information of the meeting recording data and utterance units of the text data, thereby enabling identification of a video time range of the recording data corresponding to a section of the text data that matches a search term; and to generate notification information to be transmitted to participant terminals via an electronic communication service based on the summary information, the extraction information, and the link information, and transmit the notification information to the participant terminals. This enables an integrated computer-implemented pipeline in which a single server orchestrates retrieval and decoding of meeting recordings, speech-to-text conversion, dynamic prompt construction, generative AI analysis, structured data generation, association of transcript segments with recording time ranges and shared material links, and automatic creation and transmission of minutes and action item notifications, thereby improving the technical efficiency, reliability, and usability of processing online meeting data compared to conventional fragmented solutions.

The term “meeting identification information” refers to information used by the server to uniquely identify a particular meeting instance, such as an identifier, timestamp, or combination of metadata that allows retrieval of associated recording data and related resources.

The term “meeting recording data” refers to digital data representing audio and/or video content captured during a meeting session and stored in a computer-readable format.

The term “external storage device” refers to a data storage apparatus or storage service that is accessible to the server via a communication network and is physically or logically separate from the server's local storage.

The term “communication network” refers to a wired or wireless data transmission infrastructure, such as a local area network or a wide area network, that enables exchange of information between the server, external services, and user terminals.

The term “audio signal” refers to digital data representing sound information extracted from the meeting recording data, suitable for processing by a speech recognition function.

The term “speech recognition processing apparatus” refers to a computing component, hardware module, or software service that performs automatic conversion of audio signals into text data using speech recognition algorithms.

The term “external speech recognition service” refers to a network-accessible service provided by an external computing system that receives audio data over a communication network and returns corresponding recognized text data.

The term “text data” refers to character-based digital data representing transcribed content of spoken utterances in the meeting, produced by a speech recognition process.

The term “machine learning processing apparatus” refers to a computing component or system configured to execute machine learning models, including generative AI models, for processing input data and generating analytical or predictive output data.

The term “external machine learning service” refers to a network-accessible computing service that hosts machine learning models and provides inference processing in response to input data received over a communication network.

The term “generative AI model” refers to a machine learning model, such as a large language model, trained to generate text or other data in response to input prompts and contextual information.

The term “prompt sentence” refers to text data constructed by the processor that specifies instructions, constraints, or desired output formats, and that is provided as part of the input to the generative AI model to control its processing behavior.

The term “extraction information” refers to structured or semi-structured data output from the generative AI model that represents identified meeting topics, decisions, action items, or other categorized elements derived from the text data.

The term “structured data” refers to data organized in a predefined schema or format, such as records, fields, or key-value pairs, that allow systematic storage, retrieval, and processing by a computer system.

The term “summary information” refers to condensed textual data that represents a high-level overview of the content of an entire meeting, including major topics, decisions, and outcomes.

The term “documents or materials shared during the meeting” refers to digital resources, such as files, presentations, messages, or web resources, that are presented, referenced, or exchanged among participants during the meeting.

The term “link information” refers to digital data indicating identification information or location information, such as a uniform resource locator or other reference, that enables access to documents, materials, or recording segments related to the meeting.

The term “minutes information” refers to digital data representing a formalized record of the meeting, including summaries of discussions, decisions, and action items, that can be presented as a minutes document.

The term “time information of the meeting recording data” refers to data indicating temporal positions within the meeting recording, such as timestamps, start times, or end times associated with specific segments of the recording.

The term “utterance units of the text data” refers to segments of the transcribed text corresponding to individual spoken utterances, sentences, or other logically separable portions of speech in the meeting.

The term “video time range” refers to a continuous interval of time within the meeting recording data, specified by a start time and an end time, that can be used to control playback of a particular segment.

The term “search term” refers to a string of characters or keyword expression provided by a user or application to query the text data or extraction information in order to locate relevant content.

The term “notification information” refers to digital data generated by the processor for delivery to participant terminals, including at least one of summary information, extraction information, minutes document data, action item list data, and link information.

The term “participant terminal” refers to an electronic device operated by a meeting participant, such as a personal computer, tablet, or smartphone, that is capable of receiving and displaying notification information from the server.

The term “user terminal” refers to an electronic device operated by a user that can transmit search requests, receive search results, and control playback of meeting recording data via interaction with the server.

The term “electronic communication service” refers to a software or network service that enables transmission and reception of digital messages or data between the server and terminals, such as an email service or messaging service.

The term “minutes document data” refers to digital data formatted as a document that records the proceedings of the meeting, including at least discussions, decisions, and other relevant notes, generated based on the extraction information and the summary information.

The term “action item list data” refers to digital data representing a list of tasks or follow-up actions derived from the meeting, optionally including responsible persons and due dates, generated from the extraction information.

The term “search request” refers to a message received by the server from a user terminal that includes at least a search term and optionally additional parameters, and that instructs the server to perform a search over the text data or extraction information.

In one embodiment, a server implements the claimed system as a network-accessible application executing on one or more physical machines. The server comprises at least one central processing unit (CPU), a main memory, a non-volatile storage device such as a solid-state drive, a network interface, and an operating system such as a general-purpose server operating system. The server executes application software implemented, for example, using a web application framework and one or more libraries for multimedia processing, speech recognition integration, database access, and machine learning model invocation.

The server stores meeting recording data in an external storage device, such as a networked storage service or a cloud-based object storage service, and accesses the external storage device via a communication network. The meeting recording data is typically stored in a container format such as a digital video file including an audio track and a video track. The server maintains meeting identification information in a relational database, such as a table that associates a meeting identifier with the corresponding recording file location, meeting metadata, and participant lists.

The server uses multimedia processing software such as FFmpeg to operate on the meeting recording data. The server executes FFmpeg as a separate process controlled via the operating system to extract an audio signal from the video file and convert it into a standard format such as PCM-encoded audio. The server then segments the audio signal into chunks of suitable length, determined according to constraints of an external speech recognition service or an internal speech recognition processing apparatus.

The server uses a speech recognition processing apparatus, which may be implemented as a dedicated server-side module or as an external speech recognition service accessed via an application programming interface (API). The speech recognition apparatus employs an acoustic model and a language model to decode the audio signal into text data. In one example, the acoustic model is a deep neural network that receives feature vectors such as Mel-frequency cepstral coefficients or log-mel filter bank features extracted from the audio signal. The language model may be an n-gram model, a recurrent neural network, or a transformer-based model trained on textual corpora. The speech recognition apparatus minimizes an objective function such as a cross-entropy loss or a connectionist temporal classification loss during its training phase. The server transmits the audio chunks as binary data via a secure protocol to the speech recognition apparatus and receives, for each chunk, a sequence of recognized tokens and associated timestamps. The server normalizes the tokens, reconstructs full sentences, and stores the resulting text data in the database together with utterance-level time information.

The server maintains the text data and its association with time information using specific data structures. The server, for example, stores each utterance as a record having fields including a meeting identifier, a sequence index, a start time, an end time, and an utterance string. The server may build an inverted index over the utterance strings using an information retrieval engine to support efficient search. By explicitly storing start and end times per utterance, the server ensures that later search operations can be mapped deterministically to corresponding video time ranges of the meeting recording data.

The server uses a generative AI model implemented either locally on a machine learning processing apparatus or remotely as an external machine learning service accessible via a network. In one embodiment, the generative AI model is a transformer-based large language model comprising multiple attention layers, feed-forward layers, and normalization layers. The model operates on tokenized text, where tokens are subword units or characters, and uses learned embedding vectors to represent tokens in a high-dimensional space. During training, the generative AI model minimizes a loss function such as a next-token prediction loss using gradient-based optimization, updating its weight parameters to reduce prediction error on large text corpora. The training may use techniques such as mini-batch stochastic gradient descent, adaptive learning rate schedules, and data augmentation at the text level.

The server constructs a prompt sentence as text data to control the behavior of the generative AI model. The server generates the prompt sentence dynamically based on the content and length of the text data. For example, when the text data spans many utterances, the server may generate a more constrained prompt instructing the model to output specific structured fields and to ignore irrelevant content. In one concrete example, the server uses a prompt sentence such as:
“The following text is a transcript of an online meeting.

From this transcript, extract:
1) The main topics discussed
2) The decisions made
3) A ToDo list (action items) with assignees and due dates if mentioned.
Return the result as JSON with keys: ‘topics’, ‘decisions’, ‘todos’.

### Transcript:

[TRANSCRIPT_TEXT]”

In another concrete example for summary generation, the server uses a prompt sentence such as:
“Summarize the following online meeting for participants who could not attend. Include:
1) Purpose of the meeting
2) Key discussion points
3) Final decisions
4) Next steps
Write no more than 8 bullet points.

### Transcript:

[TRANSCRIPT_TEXT]”

The server tokenizes the concatenation of the prompt sentence and the text data using the generative AI model's tokenizer and transmits the corresponding token sequence to the machine learning processing apparatus or external machine learning service via a network request. The server receives output tokens that represent generated text, and then decodes the tokens into character strings. In one embodiment, the server enforces a particular output structure by including explicit instructions in the prompt sentence, and, when necessary, by performing post-processing on the generated text using a parser. The parser checks for the presence of required keys such as topics, decisions, and todos, and, if the output deviates from the required structure, the server can modify the prompt sentence to introduce stricter constraints and re-submit the request.

The server stores extraction information produced by the generative AI model as structured data in the database. For example, the server creates tables for topics, decisions, and action items, each table referencing the meeting identifier and containing fields for textual content, optional owner information, and optional due dates. The server may link specific extraction items to one or more utterances in the text data by searching for matching substrings or by using a secondary generative AI model call that maps each extraction item to a set of utterance identifiers. This yields a higher-resolution mapping between semantically important content and the time information of the meeting recording data.

The server also generates summary information using the generative AI model. In some embodiments, the server uses the extraction information as a compact input to the generative AI model for summary generation, thereby reducing token length and processing time. The server constructs a summary prompt sentence that references the extraction information instead of the full transcript and obtains a concise meeting summary. The server stores the summary information and associates it with link information representing documents or materials shared during the meeting.

The server maintains link information for shared documents and materials by integrating with external meeting platforms or storage services. The server accesses an application programming interface exposed by the meeting platform to obtain metadata about shared files, chat messages, and resource references used during the meeting. The server scans the metadata and the text data for patterns that match network resource identifiers, and registers each detected link as a record comprising a meeting identifier, a resource type, a uniform resource identifier, and an optional description. Storing the link information in association with the text data and the recording time information allows the server to retrieve not only the relevant document but also the exact time range in the recording where the document was presented or discussed.

The server generates notification information for participant terminals. The server uses a template-based document generation engine to merge summary information, extraction information, and link information into a structured message body, such as a markup-based email body. The server constructs sections corresponding to meeting summary, topics, decisions, action items, and related links. The server then uses an electronic communication service, such as an email delivery service or a messaging gateway, to transmit the notification information to the participant terminals over the communication network. The notification information may also include identifiers or URLs that enable participant terminals to open a web-based interface and directly play back specific time ranges of the meeting recording data corresponding to selected topics or action items.

The terminal operates as a client device that receives and displays the notification information. The terminal may be a personal computer running a browser, a smartphone running a messaging application, or any similar device. The terminal retrieves messages from a mail server or message hub using standard protocols, renders the structured message body, and provides interactive controls to the user. When the user activates a control linked to a particular topic or action item, the terminal sends a request to the server that includes a reference to the associated meeting identifier and the requested content. The server responds with metadata including a video time range, and optionally with a media stream starting at that time range. The terminal then uses a media playback component to play back the requested part of the meeting recording data.

The user interacts with the system primarily through the terminal. The user reads the notification information, reviews the meeting summary and action items, and invokes search functions by entering search terms. The user can select a search result corresponding to a specific utterance or topic. The terminal transmits the search term and additional parameters such as a meeting identifier to the server. The server executes a search against the text data or extraction information, identifies matching utterance units, and obtains the associated start and end times from the database. The server returns the time range to the terminal, and the terminal updates its user interface to allow playback starting from the identified time. This tightly-coupled flow between search, text data, and video time ranges reduces the time needed for the user to locate and review specific parts of long recordings, thereby providing a technical advantage.

This system improves computer technology in several respects. First, the server organizes the processing pipeline—from recording retrieval, audio extraction, speech recognition, generative AI model invocation, structured data generation, to notification distribution—within a unified architecture that reduces redundant data transfers and conversions. By maintaining a coherent data model linking recording time information, utterance-level text data, structured extraction information, and link information, the server reduces the need for repeated parsing and alignment across heterogeneous tools. This results in lower processing latency and improved memory utilization.

Second, the server uses the generative AI model in a non-conventional manner by dynamically generating prompt sentences that are tailored to the structure and volume of the text data. The server composes prompt sentences that specifically instruct the model to produce machine-readable, structured output that can be directly stored in database fields. This differs from conventional usage where models are treated as black-box text generators for human consumption. The server's prompt design, error-checking, and re-prompting logic improve the reliability and determinism of model output, which in turn reduces post-processing complexity and computational overhead.

Third, the server employs specific data structures and indexing strategies to support efficient search and playback. By storing utterance units with explicit time ranges and building an inverted index for text search, the server can resolve search terms directly to time ranges in the recording, without scanning the entire recording or transcript each time. This architecture reduces disk I/O operations and CPU usage when servicing search requests. The result is an improvement in response time and a reduction in resource consumption compared to naive implementations.

Fourth, the server can implement additional rule-based post-processing on the extraction information that combines outputs from the generative AI model with deterministic logic. For example, the server may apply predefined rules that classify extracted items into categories based on lexical patterns, meeting roles, or time positions, and may merge or split items that are partially overlapping. This hybrid approach, in which machine-learned outputs are refined through structured, algorithmic steps, provides higher precision in identifying key decisions and action items than either manual extraction or direct model output alone. The rules can be encoded as pattern matchers or decision trees, enabling controllable behavior that is stable across large volumes of meetings.

The server can use different configurations of the generative AI model in different embodiments. In one variation, the server uses a smaller, domain-specific model deployed on-premise as the machine learning processing apparatus, which can reduce network latency and provide higher control over data residency. In another variation, the server aggregates multiple meetings' text data and uses a batched calling pattern to the external machine learning service, which reduces communication overhead and improves throughput. The server may also adjust model parameters such as temperature, maximum token count, and output format directives in the prompt sentence to optimize for accuracy, output length, and computational cost.

In some embodiments, the server employs a training or fine-tuning process for the generative AI model using meeting-specific corpora. The server collects pairs of input transcripts and desired structured outputs, computes a loss function such as cross-entropy between model predictions and target labels, and updates the model weights using gradient-based optimization. The server may apply data augmentation techniques such as paraphrasing, synonym replacement, or reordering of segments to improve robustness. These training operations contribute to reducing model errors in extracting topics, decisions, and action items, and increase consistency across different meeting formats.

The described architecture is not limited to a single type of online meeting platform or recording format. The server can support multiple input formats by configuring different multimedia processing pipelines for each format and by abstracting storage and retrieval operations behind a common interface. The server may also provide different notification channels, such as email, in-application notifications, or collaboration platform messages, as interchangeable modules. This modularity allows the system to be adapted to different deployment environments while preserving the core behavior of integrating recording data, speech recognition, generative AI analysis, structured storage, and time-range-based playback control.

By tightly integrating hardware, software, data structures, and generative AI techniques, the system provides more than a mere automation of human tasks. The server employs concrete algorithms and model structures to transform raw audiovisual data into structured, searchable, and time-aligned information, while reducing computational overhead and improving retrieval speed. The use of dynamic prompt sentences, explicit alignment of utterance units with recording time ranges, and unified management of summary information, extraction information, and link information together yield technical effects in the form of faster information access, reduced communication and storage redundancy, and improved accuracy of extracted meeting metadata.

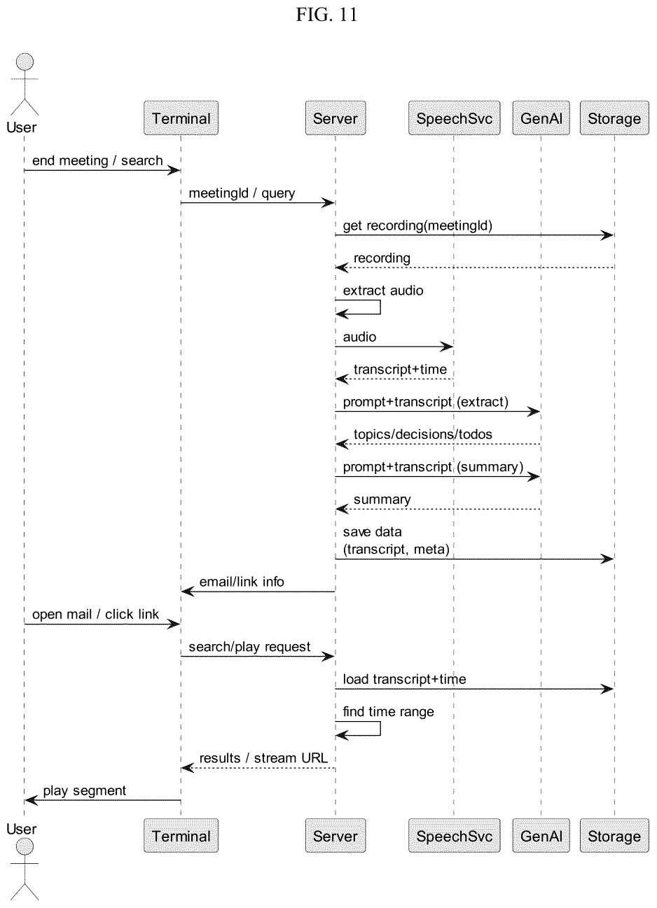

The following describes the processing flow using FIG. 11.

### Step 1:

The server receives meeting identification information from an external meeting platform or an internal scheduling system.

The server uses the meeting identification information as input to call an external storage API over a communication network and retrieves metadata including a recording file location.

The server downloads the meeting recording data, such as a video file in a container format, from the external storage device and writes the binary content to local storage.

The server outputs a stored recording file path and associated metadata into a database record.

### Step 2:

The server takes the stored recording file path as input and invokes multimedia processing software, such as FFmpeg, via the operating system.

The server configures FFmpeg to read the recording file, demultiplex audio and video streams, and convert the audio stream into a normalized audio format such as linear PCM. The server stores the resulting audio file on local storage and updates the corresponding database record with the audio file path and audio format information as output.

### Step 3:

The server uses the audio file as input and segments the audio into chunks based on duration or size constraints required by a speech recognition processing apparatus or an external speech recognition service.

The server transmits each audio chunk over a secure protocol to the speech recognition apparatus, which applies feature extraction and acoustic modeling to generate token sequences representing recognized speech.

The server receives, for each chunk, a set of recognized tokens and timestamps, and concatenates them in chronological order to construct text data that represents the entire meeting transcript.

The server outputs the text data and per-utterance time information into a transcript table in a relational database.

### Step 4:

The server takes the text data and utterance boundaries as input and performs preprocessing operations such as sentence boundary detection, normalization of punctuation, and removal of non-speech artifacts.

The server splits the text data into utterance units and assigns start and end times to each unit based on the timestamps received from the speech recognition apparatus.

The server builds an inverted index or full-text index over the utterance strings to enable efficient search on textual content.

The server outputs a set of utterance records, each including a meeting identifier, a sequence index, a start time, an end time, and an utterance string.

### Step 5:

The server uses the full transcript text as input to construct a first prompt sentence for a generative AI model.

The server analyzes the length and structure of the transcript and dynamically generates a prompt sentence that instructs the generative AI model to extract meeting topics, decisions, and action items, and to output the result in a machine-readable structure.

The server combines the prompt sentence and the transcript into a single text sequence and tokenizes it using the tokenizer associated with the generative AI model.

The server outputs a tokenized input sequence ready for submission to the machine learning processing apparatus or an external machine learning service.

### Step 6:

The server transmits the tokenized input sequence as input to the generative AI model executing on the machine learning processing apparatus or an external machine learning service.

The generative AI model processes the token sequence using a transformer-based architecture that applies attention mechanisms and feed-forward layers to compute probability distributions over output tokens conditioned on the prompt sentence and the transcript context.

The server receives the generated output tokens from the generative AI model and decodes them into text that encodes extraction information such as topics, decisions, and action items. The server parses the generated text, validates the presence of expected fields, and outputs structured extraction information records into one or more database tables.

### Step 7:

The server uses at least one of the text data and the structured extraction information as input to construct a second prompt sentence for summary generation.

The server formulates the prompt sentence to instruct the generative AI model to produce a concise summary limited to a predefined number of bullet points and focusing on specified categories such as purpose, key points, decisions, and next steps.

The server concatenates the summary prompt sentence with either the full transcript or a compact representation derived from the extraction information, then tokenizes the combined text.

The server sends the resulting token sequence to the generative AI model and receives as output a summary text, which the server stores as summary information associated with the meeting identifier.

### Step 8:

The server takes meeting metadata, text data, and platform logs as input to identify documents or materials shared during the meeting.

The server queries an external meeting platform API for shared file events, chat messages, and screen-sharing logs, and scans these records for resource identifiers such as URLs and file IDs.

The server also scans the transcript text for patterns matching network resource identifiers and merges any discovered links with the platform-provided metadata.

The server outputs link information records comprising meeting identifiers, resource types, resource locations, and optional descriptions into a link information table.

### Step 9:

The server uses the utterance records and time information as input to ensure consistent alignment between transcript segments and recording time ranges.

The server stores or updates association structures that, for each utterance unit or extraction item, associate a start time and an end time within the meeting recording data.

The server may refine these associations by matching key phrases from extraction information to utterance strings, thereby linking each extracted topic, decision, or action item to one or more specific utterance units.

The server outputs an association mapping that relates extraction information entries to precise video time ranges in the meeting recording data.

### Step 10:

The server uses the summary information, extraction information, and link information as input to construct notification information for participants.

The server loads a message template and injects dynamic content into defined sections, including a textual summary, a list of topics, a list of decisions, an action item list, and a list of related links.

The server generates a message body formatted in a markup language and assigns a subject line, optionally generated by a short prompt sentence submitted to the generative AI model for concise subject generation.

The server outputs a set of message objects, each including recipient identifiers, subject text, and message content.

### Step 11:

The server takes the message objects as input and transmits them via an electronic communication service to participant terminals.

The server connects to an email delivery service or messaging gateway using an authenticated protocol, submits each message object, and receives delivery status codes. The server logs transmission results and may retry delivery for temporary failures, thereby increasing reliability.

The server outputs a delivery status record for each participant terminal, indicating success or failure of notification information transmission.

### Step 12:

The terminal receives the notification information from a mail server or messaging service as input and stores it in a local message store.

The terminal renders the message content on a display, including sections for the summary, topics, decisions, action items, and links, using a mail client or messaging application.

The terminal accepts user interactions, such as clicks on specific topics, action items, or links, and generates corresponding requests to the server including identifiers for the selected content.

The terminal outputs user interaction events and request messages toward the server.

### Step 13:

The user reads the notification information on the terminal and selects specific items of interest.

The user inputs search terms or activates search controls provided by a web interface or application running on the terminal.

The user's search term and optional filters, such as meeting identifier or date, are packaged by the terminal into a search request and sent to the server.

The user thereby defines inputs that specify which portion of the text data or extraction information the server will analyze.

### Step 14:

The server receives the search request from the terminal as input and executes a search process over the text data or extraction information using an inverted index or full-text search engine.

The server identifies one or more utterance units or extraction items whose text content matches the search term, retrieves associated start and end times from the database, and calculates corresponding video time ranges in the meeting recording data.

The server constructs search results containing matched text snippets, meeting identifiers, and video time ranges.

The server outputs the search results to the requesting terminal in a structured response.

### Step 15:

The terminal receives the search results as input and updates its user interface to display a list of matched snippets and associated time ranges.

The terminal renders each result as a selectable item that includes a textual excerpt and a timecode representation, such as a start time and duration.

When the user selects a result, the terminal formulates a playback request including the meeting identifier and the chosen video time range and sends it to the server.

The terminal outputs playback control commands to the server.

### Step 16:

The server receives the playback request from the terminal as input and accesses the stored meeting recording data corresponding to the meeting identifier.

The server uses multimedia processing software to seek to the requested start time and, if needed, to prepare a streaming segment beginning at that time.

The server streams the segment of the recording data over the communication network using a media streaming protocol compatible with the terminal.

The server outputs a media stream that enables the terminal to play the requested video time range corresponding to the selected text content.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In modern networked computing environments, electronic meetings conducted over communication networks produce large volumes of recording information that include audio, video, shared materials, and ancillary data. Conventional systems typically store such recordings as passive media files and require users to manually replay the recording, manually identify important topics, manually extract decisions and action items, and manually locate and share links to related materials. This manual workflow is time-consuming, cognitively burdensome, and prone to omissions and inconsistencies, especially in enterprise environments where a large number of meetings are conducted on a daily basis. Existing meeting support tools may offer basic transcription or keyword search, but they generally treat the transcript as a static text artifact and do not integrate structured natural language processing, generative artificial intelligence models, and real-time delivery mechanisms in a coordinated manner. As a result, these tools do not fully leverage the capabilities of modern computing architectures to transform unstructured recording information into structured, actionable knowledge that can be consumed efficiently during and after meetings.

Furthermore, known systems for meeting transcription or summarization often operate as offline batch processes that generate a single static summary after the meeting concludes. Such systems do not provide a mechanism for continuously updating a hierarchical summary in synchronization with the progress of the meeting, nor do they support low-latency distribution of such summary information to heterogeneous terminals, including wearable display devices and portable information processing devices. Consequently, users are unable to obtain real-time, context-aware guidance during the meeting and must instead rely on their own memory or manual note-taking, leading to inefficiencies and potential degradation of decision quality.

In addition, conventional approaches that invoke generative artificial intelligence models typically pass raw or lightly processed text as input, without first applying domain-specific linguistic analysis to identify candidate topics, decisions, and action items. This lack of pre-structuring can cause the generative model to produce incomplete or inconsistent summaries, and it can hinder traceability between the generated summary and the underlying portions of the recording. It also makes it difficult to systematically associate the generated summary with location information of related materials, such as document identifiers or resource locators embedded in the recording or transcript.

Accordingly, there is a need for an improved computer-implemented technique that transforms meeting-related recording information into structured, hierarchical summary information by combining deterministic language analysis programs with generative artificial intelligence models, and that distributes the resulting summary and association information to terminals in real time and post-meeting. Such a technique should improve the functioning of the computer system itself by orchestrating multiple software components—speech recognition, natural language parsing, prompt generation, generative inference, and multi-terminal delivery—into an integrated pipeline that reduces processing latency, increases the accuracy and consistency of extracted information, and enhances the usability of meeting recordings as machine-readable, actionable data.

The specific processing by the specific processing unit 290 of the data processing device 12 in Application Example 1 is realized by the following means.

The present invention provides a server comprising a processor configured to acquire meeting-related recording information via a communication line, extract acoustic information from the acquired recording information, and convert the acoustic information into character information using a speech recognition program; the processor further configured to perform syntactic analysis and semantic analysis on the character information by using a language analysis program, to extract candidate information including topic information, decision information, and action information, and to generate a prompt sentence that instructs a generative information processing model to execute summarization processing and information structuring processing, the prompt sentence being generated by using the candidate information and at least a part of the character information as input conditions; the processor further configured to input the prompt sentence to the generative information processing model, to cause the generative information processing model to generate, based on the candidate information, hierarchical summary information including the topic information, the decision information, and the action information in the meeting, to extract location information of material information based on reference identifiers included in the recording information or the character information, and to generate association information by associating the hierarchical summary information with the location information; the processor further configured to sequentially transmit the hierarchical summary information and the association information to a display terminal in a state in which updates are possible during progress of the meeting, and to cause the display terminal to visually present the hierarchical summary information and the association information; and the processor further configured to transmit, after the meeting has ended, notification information including the hierarchical summary information and the association information to an information terminal, and to enable the notification information to be browsed on the information terminal. This enables an improved computer-centric processing pipeline in which unstructured meeting recordings are transformed into structured, hierarchical, and machine-usable summaries with linked material locations, delivered in real time and post-meeting to heterogeneous terminals, thereby reducing computational redundancy, lowering user interaction costs, and enhancing the overall efficiency and reliability of meeting information processing within the computing environment.

The term “recording information” refers to electronically stored data representing at least one portion of a meeting, including audio data, video data, screen-sharing data, text chat data, or metadata related to the meeting.

The term “acoustic information” refers to data representing sound contained in the recording information, including speech of meeting participants and background audio, in a format suitable for processing by a speech recognition program.

The term “character information” refers to textual data obtained by converting acoustic information into a sequence of characters or words using a speech recognition program.

The term “speech recognition program” refers to a software component or set of instructions that analyzes acoustic information and outputs corresponding character information, such as a transcript of spoken utterances.

The term “language analysis program” refers to a software component or set of instructions that performs at least syntactic analysis and semantic analysis on character information, including tokenization, part-of-speech tagging, parsing, or entity recognition.

The term “candidate information” refers to intermediate structured data extracted by the language analysis program from the character information, including at least topic information, decision information, and action information prior to final summarization.

The term “topic information” refers to data representing main subjects, themes, or issues discussed in the meeting, identified from the character information by linguistic or statistical analysis.

The term “decision information” refers to data representing determinations, approvals, agreements, or resolutions reached during the meeting, including associated conditions such as responsible parties or effective dates when available.

The term “action information” refers to data representing tasks, action items, or follow-up operations identified in the meeting, including optional attributes such as an assignee or a due date.

The term “prompt sentence” refers to a sequence of characters or text that encodes an instruction or query to a generative information processing model, the instruction specifying at least a summarization process or an information structuring process.

The term “generative information processing model” refers to an artificial intelligence model, such as a probabilistic language model or neural network model, that generates text or other structured output based on input character information and a prompt sentence.

The term “summarization processing” refers to processing in which the generative information processing model or the language analysis program produces a condensed representation of the meeting contents, including at least topic information, decision information, and action information, from more detailed character information or candidate information.

The term “information structuring processing” refers to processing in which extracted information is organized into a defined data structure, including grouping, ranking, or layering of topic information, decision information, and action information.

The term “hierarchical summary information” refers to summary data in which topic information, decision information, and action information are arranged in levels or layers, such as main items and subordinate items, reflecting relationships among elements of the meeting contents.

The term “reference identifier” refers to data that uniquely or semi-uniquely identifies material information within or outside the recording information, including a resource locator, document identifier, file path, or similar reference.

The term “material information” refers to content referenced or used in connection with the meeting, including documents, slide sets, images, data files, or other digital resources.

The term “location information” refers to data indicating where material information can be accessed, including a network address, resource locator, storage path, or database key.

The term “association information” refers to data indicating a linkage between hierarchical summary information and corresponding location information for material information, thereby enabling navigation from a summary element to a related resource.

The term “display terminal” refers to an electronic device having at least a display unit and a communication interface, configured to receive and visually present hierarchical summary information and association information, including but not limited to a head-mounted device, a desktop computer, or a display-equipped client device.

The term “wearable display device” refers to a type of display terminal that is configured to be worn on the body of a user, such as glasses-type devices, head-mounted displays, or other body-mounted visual output devices.

The term “superimposed display” refers to a display mode in which textual or graphical information is overlaid on other visual content within the field of view of the user, such that both the underlying content and the overlaid information are simultaneously visible.

The term “information terminal” refers to an electronic device equipped with communication, processing, and display capabilities, configured to receive and present notification information, including portable information processing devices.

The term “portable information processing device” refers to a type of information terminal that can be carried by a user and operated on battery power, such as a smartphone, a tablet computer, or a handheld computing device.

The term “notification information” refers to data sent from the server to an information terminal after the meeting, including at least hierarchical summary information and association information, and optionally additional metadata related to the meeting.

The term “schedule management program” refers to software that manages time-based events such as appointments or meetings, including calendar applications executed by an information terminal or another computing device.

The term “task management program” refers to software that manages tasks, action items, or work items, including applications for to-do lists, project management, or workflow tracking executed by an information terminal or another computing device.

The term “server” refers to a computing apparatus, which may include one or more processors, memory, storage, and communication interfaces, configured to perform at least acquisition of recording information, language analysis, prompt sentence generation, interaction with a generative information processing model, generation of hierarchical summary information and association information, and transmission of such information to terminals.

In one embodiment, a server implements the claimed system as a network-connected computing apparatus that includes at least one processor, a main memory, a non-volatile storage device, and a communication interface. The server executes an operating system such as a general-purpose server operating system and application software modules including a speech recognition program, a language analysis program, a generative AI interface module, a summarization and association module, and a transmission control module. The server is connected via a communication network to at least one terminal that functions as a display terminal, such as a wearable display device, and at least one terminal that functions as an information terminal, such as a portable information processing device.

The server uses a hardware configuration that may include one or more central processing units and, optionally, one or more graphics processing units. The server stores meeting-related recording information in the non-volatile storage device, for example in a file system or an object store. The recording information may be obtained from an external conferencing platform via an application programming interface using a communication protocol. The recording information may include audio streams, video streams, shared screen images, and metadata such as timestamps and participant identifiers.

The server uses a speech recognition program to convert acoustic information contained in the recording information into character information. The speech recognition program may be implemented by a neural network-based automatic speech recognition engine such as an encoder-decoder architecture with an attention mechanism. For example, the server may employ a model having a convolutional or recurrent encoder that receives time-frequency representations of the acoustic information, and a decoder that generates a sequence of tokens representing recognized words. The server loads model parameters, such as weight matrices and bias vectors, from the non-volatile storage device into main memory and executes numerical operations such as matrix multiplications and non-linear activation functions on the processor or GPU. The server converts the resulting token sequence into character information represented in a text format.

The server stores the character information in a structured form. For example, the server represents the character information as a sequence of transcript segments, each segment including at least a start time, an end time, and a text string. The server may further store speaker identification tags if the speech recognition program outputs speaker labels. This structured storage allows the server to maintain a deterministic mapping between individual words and corresponding time ranges in the recording information.

The server executes a language analysis program on the character information. The language analysis program is implemented as a natural language processing pipeline including tokenization, sentence boundary detection, part-of-speech tagging, syntactic dependency parsing, and named entity recognition. The server may use a model-based library such as a transformer-based language analysis engine that has been trained on large corpora. The server loads a pretrained language model into memory and executes vectorized operations on the processor or GPU to compute contextual representations of tokens.

The server, by executing the language analysis program, extracts candidate information that includes topic information, decision information, and action information. For topic information, the server identifies noun phrases and specific domain-related terms based on part-of-speech tags and dependency relations. The server may compute term frequency and inverse document frequency values over the character information and cluster semantically similar terms using vector representations. For decision information, the server recognizes patterns such as modal verbs combined with verbs of commitment and agreement. The server may apply rule-based filters that check for syntactic configurations like a subject corresponding to a group of participants and a predicate expressing resolution or approval. For action information, the server identifies imperative sentences or future-tense commitments with associated entities and temporal expressions. The server stores the candidate information in data structures such as lists of objects, where each object contains at least a text span, a type label indicating topic, decision, or action, associated entities, and time ranges.

The server generates a prompt sentence for a generative AI model based on the candidate information and at least part of the character information. The server constructs the prompt sentence as a text string that includes explicit instructions and structured sections. For example, the server may generate a prompt sentence such as:
“You are an assistant that summarizes business meetings.

### Task:

From the following extracted items and transcript snippet, produce:
1) A concise list of main topics.
2) A list of decisions (with clear wording).
3) A list of ToDo items with assignees and due dates when available.

### Extracted Topics:

[topic bullets here]

### Extracted Decisions:

[decision sentences here]

### Extracted ToDos:

[ToDo sentences here]

### Transcript Snippet:

[selected transcript text]

Please respond in English with clearly separated sections: ‘Topics’, ‘Decisions’, and ‘ToDo items’.”

The server writes the candidate information into the brackets and selects relevant portions of the character information as the transcript snippet. The server may apply size constraints to ensure that the prompt sentence does not exceed a predetermined character or token limit. The server communicates with a generative AI model via a generative AI interface module. The generative AI model is implemented, for example, as a transformer-based neural network having multiple self-attention layers, feedforward layers, and layer normalization components. The server sends the prompt sentence as an input sequence of tokens to the generative AI model. In one embodiment, the generative AI model resides on a remote computing resource accessible through an application programming interface. The server converts the prompt sentence into an appropriate format, such as a sequence of numerical identifiers corresponding to tokens, and transmits it via the communication interface.

The server receives output from the generative AI model in the form of generated text. The generative AI model computes the output by successively predicting next-token probability distributions conditioned on the prompt sentence, using learned parameters that have been obtained by pretraining on text corpora and optionally fine-tuned on meeting-related data. During training, the generative AI model minimizes a loss function such as cross-entropy between predicted token distributions and reference tokens, and updates parameters through gradient-based optimization such as stochastic gradient descent or Adam. These details of the training process determine the internal representation and enable the model to capture complex language patterns. At inference time, the server applies decoding algorithms such as greedy decoding or beam search to obtain a deterministic text output from the probability distributions.

The server parses the generated text to obtain hierarchical summary information including topic information, decision information, and action information. The server may rely on section headers inserted by the generative AI model, such as “Topics”, “Decisions”, and “ToDo items”, and split the generated text accordingly. The server then analyzes each list item by simple pattern matching or additional language analysis to extract structured attributes such as labels, descriptions, and relationships between items. The server stores the hierarchical summary information as a tree-like or nested data structure, where parent nodes represent main topics and child nodes represent associated decisions and actions. This hierarchical representation improves data organization, facilitates indexed access, and reduces the amount of data required to be transmitted to terminals compared to raw transcripts.

The server further extracts location information for material information associated with the meeting. For this purpose, the server examines the recording information and the character information to detect reference identifiers such as resource locators, document identifiers, and file names. The server may use regular expression matching for patterns corresponding to network addresses and may also use named entity recognition specialized for document references. The server then produces association information that binds elements of the hierarchical summary information to corresponding location information. For example, when the server detects that a particular topic refers to a presentation file identified by a resource locator, the server stores a mapping from a node in the hierarchical summary structure to that resource locator.

The server transmits the hierarchical summary information and the association information to a display terminal. In a typical embodiment, the display terminal is a wearable display device such as a head-mounted display or a glasses-type device. The server establishes a persistent communication channel to the display terminal, for example using a protocol that supports low-latency message delivery. The server encodes the hierarchical summary information and association information as compact messages and sends updates whenever new topics, decisions, or actions are added, or when existing elements are modified. The display terminal receives the messages, decodes them, and renders textual overlays in the user's field of view. The display terminal operates a local rendering program that arranges the summary information in a minimal, non-obstructive layout that can be superimposed on top of other visual content such as video. This allows the user to view the meeting and simultaneously see key summary items.

The server also transmits notification information to an information terminal after the meeting has ended. The notification information includes at least the final hierarchical summary information and the association information. The server may format the notification information as a structured document or a message that can be interpreted by a mail client or a dedicated application on the information terminal. The information terminal, typically a portable information processing device such as a smartphone or tablet, receives the notification information over a communication network. The information terminal displays the notification information on a graphical user interface, allowing the user to browse the summarized topics, decisions, action items, and linked materials.

The server may further output the action information included in the notification information in a format that is directly linkable to an external schedule management program or task management program executing on the information terminal or another device. For example, the server may generate action entries having fields such as title, due date, assignee, and description, and encode them in a structured format that can be imported into a calendar or task list. This structure enables automated or semi-automated registration of schedules and tasks, thereby reducing user input operations. Because the server uses structured representations and hierarchical relationships, the amount of user correction needed is reduced compared to unstructured text, and the action information can be more reliably mapped to application-specific fields.

The server achieves technical improvements over conventional systems through the combination of deterministic language analysis and generative AI model-based summarization using prompt sentences. By first using a language analysis program to extract candidate information and then generating a prompt sentence that explicitly encodes this structure, the server constrains the input to the generative AI model and reduces ambiguity. This reduces the required length of the prompt sentence and decreases the computational load on the generative AI model by focusing on salient portions of the character information. As a result, the server can obtain more accurate and consistent hierarchical summary information using fewer tokens and in less time than when using untreated or raw transcripts. The data structures used for candidate information and hierarchical summary information also enable the server to update only the changed portions of the summary, thereby reducing communication load when transmitting updates to the display terminal.

The server improves computer technology by defining specific data structures, processing sequences, and model interface mechanisms that optimize the internal handling of meeting-related data. The use of segmented transcripts with timestamps, candidate information tables keyed by time and type, and hierarchical summary trees lowers memory fragmentation and facilitates indexed retrieval. The server, by integrating these structures with streaming transmission mechanisms, reduces latency between the occurrence of an event in the meeting and the presentation of the corresponding summary element on the display terminal. This is not merely automation of human note-taking; rather, it is an improvement in the way computer systems process, structure, and distribute large volumes of unstructured audio-text data in real time.

The server may employ different variants of generative AI models. In one embodiment, the server uses a transformer decoder architecture with a fixed number of layers, each layer comprising multi-head self-attention and position-wise feedforward sublayers. The model uses positional encodings to represent token order and applies layer normalization to stabilize training. The model parameters are learned offline using training data that includes transcripts of meetings annotated with topics, decisions, and action items. The server uses a loss function that combines token-level cross-entropy with auxiliary terms that encourage accurate reproduction of structural markers such as list bullets or section headers. During training, the server or an external training system executes mini-batch gradient descent, computes gradients via backpropagation, and updates model weights. The resulting model is stored on non-volatile storage and loaded into the server for inference.

The server applies non-conventional rules and methods for extracting candidate information and constructing prompt sentences. For example, the server uses custom heuristics to select transcript segments that maximize informational density, such as segments that contain both a named entity and a date expression, or segments where a change of topic is detected by abrupt changes in term distributions or embedding vectors. The server may rank sentences by a scoring function that combines linguistic indicators (e.g., presence of verbs of decision or obligation) and statistical indicators (e.g., high term novelty relative to previous context). This scoring function is a purely computational construct that does not mirror human note-taking behavior, and it is specifically designed to optimize the quality of input to the generative AI model, thereby enhancing the technical performance of the overall system.

The server can be configured in multiple alternative embodiments. In another embodiment, the server executes all natural language processing locally, including the generative AI model, by using dedicated hardware accelerators. In still another embodiment, the server offloads primarily the generative inference to a remote AI processing service while performing speech recognition and language analysis locally. In a further embodiment, the server utilizes a different class of generative models, such as sequence-to-sequence encoder-decoder models, and adapts the prompt sentence to include explicit input-output examples demonstrating desired summary formats. In each case, the basic scheme of extracting candidate information, constructing a prompt sentence, generating hierarchical summary information, and associating it with material location information remains the same, thus supporting the scope of the claims.

The terminal can also vary in form. In one embodiment, the display terminal is a stationary display device such as a desktop monitor connected to a thin client, and the server renders summary overlays via a browser-based interface. In another embodiment, the display terminal is a wearable device that supports augmented reality projection. In yet another embodiment, the information terminal is a laptop computer running a native application that can receive updates both during and after the meeting. The described system thus provides multiple practical configurations while preserving the underlying technical contributions related to structured processing, efficient transmission, and real-time visualization of meeting information.

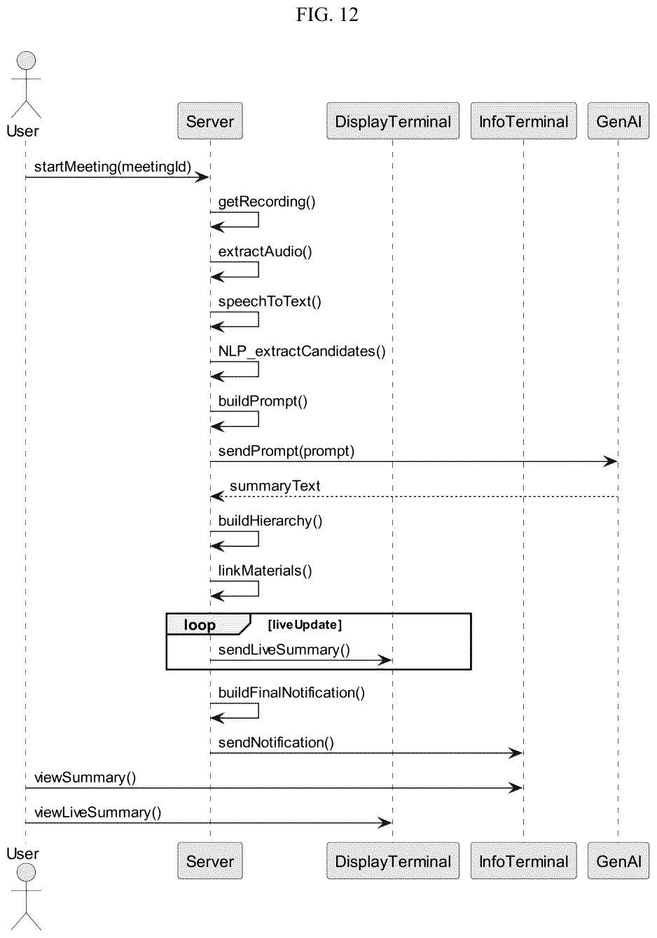

The following describes the processing flow using FIG. 12.

### Step 1:

The server acquires meeting-related recording information.

The server receives, as input, meeting identification information such as a meeting ID or recording ID via a network request from a terminal or a scheduling system. Based on this input, the server calls an external conferencing service API over a communication network and downloads recording files that include at least audio data and optionally video, screen sharing, and metadata. The server performs data transfer operations using a communication protocol and writes the received byte streams into non-volatile storage, generating as output a set of stored recording files associated with the meeting identification information.

### Step 2:

The server extracts acoustic information from the recording information.

The server takes, as input, the stored recording files that may contain multiplexed audio and video streams. The server executes a multimedia processing tool to demultiplex the recording files and to extract an audio stream in a standardized format, for example a mono linear PCM signal with a fixed sampling rate. The server performs decoding and re-encoding operations on the media frames and outputs a normalized audio file that constitutes the acoustic information for subsequent processing.

### Step 3:

The server converts the acoustic information into character information using a speech recognition program.

The server receives, as input, the normalized audio file produced in Step 2. The server processes the audio by segmenting it into frames, computing acoustic features such as Mel-frequency cepstral coefficients, and feeding these features into a neural network-based automatic speech recognition model. The server executes matrix multiplications and non-linear activations in the model's encoder, and uses a decoder and output layer to obtain token probability distributions for each time step. The server then decodes the probabilities into a sequence of text tokens and concatenates them into sentences, generating as output structured character information that includes a time-aligned transcript of the meeting.

### Step 4:

The server structures the character information into transcript segments.

The server uses, as input, the raw character information output from Step 3, including word or token timestamps. The server groups contiguous tokens into transcript segments based on time boundaries and sentence delimiters, performing operations such as sentence boundary detection and time-window grouping. The server stores each segment with associated fields including start time, end time, and text content, thereby producing as output a list of transcript segments that allows efficient indexing and retrieval.

### Step 5:

The server performs linguistic analysis on the character information using a language analysis program.

The server takes, as input, the list of transcript segments from Step 4. For each segment, the server applies natural language processing operations including tokenization, part-of-speech tagging, syntactic dependency parsing, and named entity recognition by executing a pretrained language model in memory. The server computes contextual vector representations and determines grammatical relations among tokens, thereby generating as output an annotated transcript in which each token is associated with linguistic attributes and entity labels.

### Step 6:

The server extracts candidate topic information from the annotated transcript.

The server uses, as input, the annotated transcript from Step 5. The server identifies noun phrases, domain-relevant terms, and recurring key phrases by examining part-of-speech tags, dependency structures, and entity types. The server calculates statistical measures such as term frequency and inverse document frequency across segments and clusters semantically similar terms using their vector representations. Based on these operations, the server outputs candidate topic information, represented as a set of topic entries each containing a label, representative phrases, and references to underlying transcript segments.

### Step 7:

The server extracts candidate decision information from the annotated transcript.

The server receives, as input, the annotated transcript with syntactic and semantic information. The server searches for sentences that contain linguistic patterns indicative of decisions, such as modal verbs combined with verbs of commitment, approval, or agreement. The server applies rule-based filters that examine dependencies between subjects, verbs, and objects, and checks for entities such as dates, times, and organizations within these sentences. As a result of these computations, the server outputs candidate decision information as a list of decision entries, each entry including at least a decision statement, any associated participants, temporal expressions, and corresponding time ranges in the recording.

### Step 8:

The server extracts candidate action information from the annotated transcript.

The server uses, as input, the same annotated transcript. The server detects imperative constructions, future-tense commitments, and request patterns by analyzing verb forms and sentence mood. The server further identifies assignees from person entities and due dates from date or time entities. The server aggregates this data into structured action entries, each entry containing an action description, an optional assignee, an optional due date, and a link to one or more transcript segments. The output of this step is candidate action information that captures potential ToDo items derived from the meeting.

### Step 9:

The server assembles candidate information into a structured intermediate representation.

The server takes, as input, the candidate topic information from Step 6, the candidate decision information from Step 7, and the candidate action information from Step 8. The server normalizes the extracted elements by removing duplicates, merging similar entries based on text similarity and shared entities, and assigning confidence scores derived from linguistic and statistical features. The server organizes these entries into a unified data structure, such as a table or object graph, which serves as candidate information. This candidate information is output as a compact, structured summary of extracted items prior to generative processing.

### Step 10:

The server constructs a prompt sentence for a generative AI model.

The server uses, as input, the candidate information from Step 9 and selected portions of the character information from Step 4. The server formats this input into a text template that includes instructions and labeled sections. The server concatenates standard instruction text with bullet lists representing topics, decisions, and actions, and appends a transcript snippet. For example, the server may generate a prompt sentence such as:
“You are an assistant that summarizes business meetings.

### Task:

From the following extracted items and transcript snippet, produce:
1) A concise list of main topics.
2) A list of decisions (with clear wording).
3) A list of ToDo items with assignees and due dates when available.

### Extracted Topics:

[topic bullets here]

### Extracted Decisions:

[decision sentences here]

### Extracted ToDos:

[ToDo sentences here]

### Transcript Snippet:

[selected transcript text]

Please respond in English with clearly separated sections: ‘Topics’, ‘Decisions’, and ‘ToDo items’.”

The server outputs this constructed text as a prompt sentence that is optimized to guide the generative AI model.

### Step 11:

The server transmits the prompt sentence to a generative AI model and receives generated text.

The server receives, as input, the prompt sentence from Step 10. The server encodes the prompt sentence into a sequence of tokens using a tokenizer corresponding to the generative AI model and sends the tokens over a communication interface to a model execution environment. The generative AI model performs internal computations, such as multi-head self-attention and feedforward operations, to produce probability distributions over tokens and generates output text by sequential decoding. The server collects the generated tokens, converts them back into characters, and obtains, as output, generated text that includes refined topic, decision, and action descriptions.

### Step 12:

The server parses the generated text into hierarchical summary information.

The server uses, as input, the generated text obtained in Step 11. The server scans the text for section headers and list markers such as “Topics”, “Decisions”, and “ToDo items” and splits the text into corresponding sections. The server further divides each section into individual list items and may apply additional simple language analysis to extract attributes such as labels, descriptions, and implied relationships. The server then builds a hierarchical data structure where top-level nodes represent topics, and child nodes represent decisions and actions associated with each topic. The output of this step is hierarchical summary information that is suitable for efficient navigation and display.

### Step 13:

The server extracts location information for material information and generates association information.

The server receives, as input, the recording information from Step 1, the character information from Step 3, and the hierarchical summary information from Step 12. The server searches the recording information and character information for reference identifiers such as resource locators, document IDs, or file names using pattern matching algorithms and entity recognition specialized for document references. The server matches these identifiers to corresponding summary elements by comparing contextual text or timing information. The server then constructs association information that binds nodes of the hierarchical summary structure to specific location information entries, and outputs this association information as a mapping between summary items and material resources.

### Step 14:

The server prepares update messages for transmission to a display terminal.

The server uses, as input, the hierarchical summary information from Step 12 and the association information from Step 13. The server identifies which parts of the summary have been newly created or updated since the last transmission by comparing data version identifiers or timestamps. The server encodes only the changed elements into compact update messages, including identifiers, text content, and linked location information. By limiting the payload to incremental changes, the server reduces communication volume and processing overhead. The output of this step is a sequence of update messages ready to be sent to the display terminal.

### Step 15:

The server transmits update messages to the display terminal for real-time visual presentation.

The server receives, as input, the update messages generated in Step 14. The server sends these messages through a low-latency communication channel to the display terminal. The display terminal receives the messages and decodes the hierarchical summary information into an internal representation, then updates the rendering of text overlays or interface elements in the user's field of view. The output of this step is an updated on-screen or in-view summary that reflects the latest topics, decisions, and action items while the meeting is in progress.

### Step 16:

The server compiles final notification information after the meeting.

The server uses, as input, the accumulated hierarchical summary information and association information after the meeting has concluded. The server aggregates all summary elements, resolves any remaining duplicates or conflicts, and ensures that all linked materials are represented in the association information. The server then formats this data into notification information that includes sections for topics, decisions, action items, and linked materials in a layout suitable for later review. The server outputs this compiled notification information as a structured message or document.

### Step 17:

The server transmits the notification information to an information terminal.

The server receives, as input, the final notification information from Step 16 and destination information such as user addresses or device identifiers. The server selects an appropriate transmission method, for example email or a push messaging service, and encapsulates the notification information accordingly. The server then sends the message across a communication network to the information terminal, which receives and stores the notification. The output of this step is a delivered notification available for display on the information terminal.

### Step 18:

The terminal presents the notification information and supports linkage to external management programs.

The terminal uses, as input, the notification information received from the server in Step 17. The terminal parses the structured content and renders it on a graphical user interface, displaying hierarchical sections for topics, decisions, action items, and material links. For action information, the terminal may provide user interface controls that allow the user to export specific items into a schedule management program or a task management program. The terminal performs conversion of selected action entries into the format required by those programs and invokes the programs with corresponding data, thereby outputting newly created events or tasks based on the action information.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meeting support systems primarily focus on simple recording and static storage of meeting content, and on naïve calendar aggregation for scheduling. Such systems typically treat meeting recordings, textual minutes, presentation materials, and participant schedules as separate and weakly linked data silos. As a result, a general-purpose computer is forced to execute multiple disjoint applications and manual operations: a user must manually review long recordings, manually draft minutes and notification messages, and manually reconcile disparate calendar information to schedule follow-up meetings. This leads to excessive consumption of processing resources for repetitive parsing and formatting, redundant data transfers between applications, and latency in producing useful outputs for users.

In particular, when a large meeting recording is stored, a conventional system often requires a user to perform repeated seek operations in a media player, visually scan timelines, and cross-reference external notes or slide materials. The processor in such a system performs low-level media decoding and playback without higher-level, semantically indexed access to the content. Similarly, for scheduling, conventional systems perform only straightforward retrieval of calendar entries, leaving conflict resolution, prioritization, and constraint application to manual user operations. The computer thereby acts merely as a passive container, and its processing architecture does not exploit content-aware automation to reduce the computational burden associated with user-driven iteration.

Furthermore, existing systems that attempt to incorporate machine learning or natural language processing tend to apply such techniques in isolated subtasks, such as transcription alone or summary generation alone. The processor is not architected to coordinate prompt-driven generative models across the full lifecycle of meeting processing: from audio-to-text conversion, to semantic extraction of topics, decisions, and tasks, to structured association with time-coded video segments, to constraint-based schedule computation, and to automated generation of personalized notifications and messages. As a consequence, the general-purpose computer executes fragmented pipelines with repeated parsing and formatting, incurs unnecessary I/O overhead between components, and cannot efficiently provide direct, time-segment-level retrieval in response to user queries.

Another technical problem resides in the interaction model between the user and the system. When a user issues a natural-language request such as “schedule the next 60-minute meeting within the next two weeks, avoiding Fridays and holidays,” conventional systems do not structurally interpret such instructions. Instead, they require the user to perform multiple graphical user interface operations to specify constraints, which triggers multiple redundant calendar queries and conflict checks. The processor thus performs unoptimized, repeated computations over schedule data, which increases processing time and consumes network and memory resources, especially in environments with many participants or multiple heterogeneous scheduling services.

Accordingly, there is a need for a computer-implemented technique that re-architects the processor's operation so that the processor can: (i) centrally manage meeting video, audio, transcript, and presentation links; (ii) employ generative AI models via prompt sentences in a coordinated and repeatable way; (iii) generate structured semantic indices and time-segment associations for the meeting content; (iv) compute common availability across multiple participants based on heterogeneous schedule services; and (v) automatically generate and transmit meeting summaries, minutes, and scheduling notifications. By integrating these operations into a single prompt-orchestrated processing flow, the system can technically improve the functioning of the computer itself, reducing redundant data handling, lowering user interaction overhead, and enabling more efficient search and retrieval of specific meeting segments.

The specific processing by the specific processing unit 290 of the data processing device 12 in Example 2 is realized by the following means.

The present invention provides a server comprising a processor configured to acquire video information and audio information of a meeting, convert the audio information into character information, generate prompt sentences that instruct a generative information processing model to (i) extract topic information, decision information, and task information from the character information, (ii) summarize extraction results, and (iii) associate the extraction results with reference information to presentation information and with time information in the video information, input the prompt sentences to the generative information processing model so as to cause the generative information processing model to perform the extraction, summarization, and association, calculate free-time information of each participant based on participant information and schedule information acquired from at least one schedule management service, specify common free-time information shared by a plurality of participants, generate prompt sentences that instruct the generative information processing model to determine date-and-time information of a next meeting based on the specified common free-time information and predetermined constraint conditions, input the prompt sentences to the generative information processing model so as to cause the generative information processing model to determine the date-and-time information of the next meeting, generate outline information and notification information based on the determined date-and-time information of the next meeting, the topic information, the decision information, the task information, the reference information, and the time information, transmit the notification information to a terminal device via a communication network, receive search-word information from the terminal device, generate prompt sentences that instruct the generative information processing model to specify a corresponding time period in the video information based on the search-word information, the character information, and the time information, input the prompt sentences to the generative information processing model so as to cause the generative information processing model to specify the corresponding time period, and provide playback control information of the corresponding time period to the terminal device. This enables the server to implement an integrated, prompt-orchestrated processing pipeline that reduces redundant parsing and manual operations, improves internal data structures for meeting content and schedules, accelerates computation of common availability, and enhances the computer's capability to provide semantically indexed, time-aligned access to meeting information in response to user interactions.

The term “video information” refers to digital data representing moving images of a meeting, including time-coded image frames and associated metadata indicating temporal positions within the meeting.

The term “audio information” refers to digital data representing sound captured during a meeting, including participants' speech and any other audible events, which can be processed by a computing device.

The term “character information” refers to textual data obtained by converting audio information into written form, including transcripts of spoken utterances with or without associated timestamps.

The term “meeting” refers to an event in which a plurality of participants exchange information, discuss topics, make decisions, or assign tasks, whether conducted in person, remotely, or in a hybrid format.

The term “topic information” refers to structured data representing main subjects, themes, or agenda items discussed during a meeting, derived from character information.

The term “decision information” refers to structured data representing resolutions, agreements, or determined policies reached during a meeting, derived from character information.

The term “task information” refers to structured data representing action items, work assignments, or follow-up activities identified during a meeting, including, when available, responsible entities and due dates, derived from character information.

The term “presentation information” refers to digital materials used to convey content during a meeting, including but not limited to slide files, documents, images, and other visual or textual resources.

The term “reference information” refers to data that identifies or points to presentation information, such as resource identifiers, network locations, or links that enable access to the presentation information.

The term “time information” refers to data indicating temporal positions or intervals within video information or audio information, including timestamps, start times, end times, and durations associated with segments of a meeting.

The term “participant information” refers to data identifying entities that attend or are invited to a meeting, including identifiers such as names, contact addresses, account identifiers, and associated scheduling accounts.

The term “schedule information” refers to data representing planned time allocations of a participant, including appointments, busy intervals, and free intervals, obtained from a schedule management service.

The term “schedule management service” refers to an information processing service that stores and provides schedule information for one or more entities, accessible via a communication network and an application programming interface.

The term “free-time information” refers to data representing time intervals during which a participant is available for a meeting, computed by subtracting busy intervals from a defined temporal range.

The term “common free-time information” refers to data representing time intervals that are simultaneously available to a plurality of participants, obtained by computing an intersection of free-time information for the participants.

The term “date-and-time information” refers to data specifying one or more calendar dates and corresponding time intervals, used to define when a meeting is to be held.

The term “constraint conditions” refers to rules or parameters that restrict or guide selection of date-and-time information, including but not limited to meeting duration, permissible dates, permissible times, days of the week, and exclusion criteria.

The term “outline information” refers to summarized data describing key aspects of a meeting, including topic information, decision information, task information, and optionally links to related resources and time segments.

The term “notification information” refers to message data prepared for transmission to one or more terminal devices, including at least date-and-time information for a meeting and optionally outline information, reference information, and access information.

The term “terminal device” refers to an information processing device operated by a user, including but not limited to a personal computer, a mobile computing device, or a communication device capable of receiving and displaying notification information and controlling playback of media.

The term “communication network” refers to a wired or wireless data communication infrastructure, including local networks and wide-area networks, that enables data exchange between the server and one or more terminal devices.

The term “search-word information” refers to data representing one or more search terms, keywords, or phrases input by a user to request retrieval of relevant portions of meeting content.

The term “corresponding time period” refers to a time interval within video information or audio information that is identified as relevant to search-word information or to particular topic, decision, or task information.

The term “playback control information” refers to data used by a terminal device to control reproduction of video information or audio information, including at least time positions such as start times and optionally end times, as well as identifiers of media resources.

The term “generative information processing model” refers to a parameterized computational model that, when provided with input data and a prompt sentence, generates output data such as text, structured data, or other content through learned statistical or neural network-based transformations.

The term “prompt sentence” refers to information including text or structured instructions provided to a generative information processing model, specifying a desired processing operation, output format, or semantic focus for the model's response.

The term “minutes information” refers to structured or semi-structured textual data representing a formal record of a meeting, including summaries of discussed topics, decisions, and tasks.

The term “message information” refers to textual or multimedia data forming a communication intended to be sent to one or more recipients, including notifications, summaries, and instructions related to a meeting.

The term “communication destination” refers to an endpoint address or account identifier used to deliver message information to a participant, including electronic mail addresses or messaging service identifiers.

The term “meeting-setting request sentence” refers to a natural-language instruction provided by a user that requests scheduling of a meeting and may include constraints such as desired duration, dates, times, and exclusions.

The term “constraint information” refers to structured data extracted from a meeting-setting request sentence, representing parameters such as meeting-duration information, period information, day-of-week condition information, and exclusion condition information.

The term “meeting-duration information” refers to data specifying a desired length of time for a meeting, expressed as a temporal quantity.

The term “period information” refers to data specifying a temporal range, such as a start date and an end date, within which a meeting is to be scheduled.

The term “day-of-week condition information” refers to data specifying one or more days of the week that are permitted or preferred, or that are to be avoided, for scheduling a meeting.

The term “exclusion condition information” refers to data specifying dates, times, or conditions under which a meeting should not be scheduled, such as particular days, holidays, or conflicting events.

In one embodiment, a server provides a meeting-support system that integrates media processing, semantic analysis, schedule computation, and communication generation using a generative AI model driven by prompt sentences. The server operates in cooperation with at least one terminal and at least one user.

The server includes a hardware platform comprising at least one central processing unit (CPU), a main memory, a non-volatile storage device, a network interface, and, in some configurations, a hardware accelerator such as a graphics processing unit (GPU) or tensor processing unit (TPU). The CPU may be, for example, a multi-core processor of a general-purpose architecture. The non-volatile storage device may be a solid-state drive or other mass storage device. The network interface provides connectivity to a communication network such as a local area network and a wide area network. The server executes an operating system such as a general-purpose server operating system and middleware including a web server, an application server, and a database management system such as a relational database.

The terminal includes a processor, a memory, a display, an input interface, and a communication interface. The terminal executes a web browser or a dedicated client application that communicates with the server over the communication network. The user operates the terminal to view meeting information, input search terms, and provide natural-language scheduling instructions.

The server stores meeting-related data in data structures implemented in the database system. In one example, the server maintains a meeting table that stores identifiers for meetings, references to video information and audio information, and metadata such as start time and duration. The server maintains a transcript table that stores character information for each utterance, along with associated time information such as a start timestamp and an end timestamp. The server maintains a participant table that stores participant information including identifiers and communication destinations. The server further maintains schedule tables that store schedule information retrieved from at least one schedule management service, represented as busy intervals and free-time information. The server also maintains tables for topic information, decision information, task information, and reference information to presentation information.

The server acquires video information and audio information of a meeting from a media capture system or from a media storage system. The video information includes encoded frames and associated timecodes. The audio information is decoded into a waveform representation and processed by an automatic speech recognition (ASR) engine to produce character information. The ASR engine may be a deep neural network model, such as a recurrent neural network, a convolutional neural network, or a transformer-based acoustic model, trained with paired audio-text data to minimize a sequence-level loss function such as cross-entropy or a connectionist temporal classification loss. The server stores the resulting character information in the transcript table together with time information that aligns the text with the video information.

The server uses a generative AI model to perform semantic extraction and summarization. In one embodiment, the generative AI model is implemented as a transformer-based neural network comprising a plurality of attention layers, feed-forward layers, normalization layers, and embedding layers. The model is trained on large-scale text corpora using a language modeling objective that minimizes a prediction error between predicted tokens and actual tokens. During fine-tuning, the model may be adapted using meeting transcripts and structured annotations of topics, decisions, and tasks. The training process updates model weights by gradient-based optimization, such as stochastic gradient descent with adaptive learning rate control, and uses regularization techniques such as dropout and data augmentation. This configuration enables the model to transform input character information into structured semantic outputs with improved accuracy.

The server generates prompt sentences that explicitly instruct the generative AI model to perform particular operations in relation to the meeting data. For example, the server generates a prompt sentence in the following form:
“You are a meeting analysis assistant. Given the following meeting transcript, extract (1) a list of main topics, (2) a list of decisions, and (3) a list of action items with responsible persons and due dates if mentioned. Then summarize each element in one or two sentences. Return plain text sections labeled ‘Topics:’, ‘Decisions:’, and ‘Action items:’.”

The server concatenates the prompt sentence with the character information and supplies this combined text to the generative AI model. Internally, the generative AI model tokenizes the input, encodes tokens into high-dimensional vector representations, applies multi-head attention operations to capture dependencies across the transcript, and produces output token sequences. The server decodes the output tokens to obtain topic information, decision information, and task information. The server parses the output into structured fields and stores them in corresponding tables.

The server associates time information and reference information with the extracted semantic information. The server computes, for each extracted topic or decision, a set of representative phrases or sentences that appear in the character information. The server retrieves the time information for those phrases from the transcript table and calculates corresponding time intervals in the video information. The server stores, for each topic or decision, a mapping to one or more time segments. The server also links each extracted item to presentation information by comparing textual references in the character information, such as document titles or slide identifiers, to stored resource identifiers of presentation materials. This creates a time-indexed and material-linked semantic index that the server can query efficiently.

The server acquires schedule information from at least one schedule management service by sending programmatic requests over application programming interfaces. The server receives schedule data in a structured representation, such as events with start and end times and status indicators. The server normalizes time zones and converts events into internal interval objects stored in the schedule tables. The server then computes free-time information by subtracting busy intervals from a specified working hours interval for each participant. The server uses an interval tree or segment tree data structure in memory to efficiently compute the intersection of free-time information across multiple participants. This yields common free-time information that represents candidate time slots for a next meeting.

The server may use the generative AI model to refine selection of date-and-time information for the next meeting. In one example, the server generates a prompt sentence:
“Here is a list of common free time slots for all participants: [slot list]. Choose the best single 60-minute slot, preferring times between 10:00 and 16:00 on weekdays and avoiding Fridays. Provide your choice and a short explanation in plain text.”

The server includes the list of candidate slots in the input text and supplies it to the generative AI model. The generative AI model evaluates the slots using internal learned preferences, but the server controls the decision by verifying that the proposed slot satisfies explicit constraint conditions. In this embodiment, the AI model produces a recommendation, and the server enforces consistency with the computed common free-time information and constraint conditions by applying rule-based validation. This combination of learned evaluation and deterministic validation improves both flexibility and reliability of scheduling.

The server generates outline information and notification information for the meeting. Based on the topic information, decision information, and task information, the server forms a hierarchical data structure that represents the outline information, including references to associated time segments and presentation materials. The server then generates a prompt sentence for message drafting, such as:
“Compose an email to the meeting participants. Include: (1) the date and time of the next meeting: [date-time], (2) a concise summary of main topics, (3) a bullet list of decisions, and (4) a bullet list of action items with responsible persons and due dates. Use a polite business tone.”

The server concatenates the prompt sentence with the structured outline information formatted as descriptive text and supplies it to the generative AI model. The generative AI model outputs natural-language message information. The server edits or formats the output if necessary, then transmits the notification information to the terminals via the communication network using an electronic mail protocol or another messaging protocol. The user operates the terminal to receive and view the notification information. The terminal displays the outline information, links to presentation information, and links to specific time segments. When the user selects a link corresponding to a time segment, the terminal sends a request including the segment identifier to the server. The server returns playback control information including a media resource identifier and a start time. The terminal configures a media playback component to begin rendering the video information at the specified time. This direct segment-level access reduces the number of seek operations and decoding overhead compared to manual scrubbing through the entire recording.

The user can also input search-word information or a natural-language query on the terminal. For example, the user may input:
“Show me the part of the meeting where the final decision on the project deadline was made.”

The terminal sends the search-word information and an identifier of the meeting to the server. The server generates a prompt sentence in the following form:
“Given the following meeting transcript with timestamps, and the query ‘Show me the part of the meeting where the final decision on the project deadline was made’, identify the three most relevant time segments. For each segment, provide the start time, the end time, and a short description.”

The server concatenates the prompt sentence with the character information and time information and provides it to the generative AI model. The generative AI model internally computes contextual similarity between the query and each segment of the transcript by propagating token embeddings through multiple attention layers. The output includes descriptions and approximate time boundaries. The server refines these boundaries by snapping them to actual utterance timestamps stored in the transcript table. The server then produces playback control information for each segment and returns it to the terminal. In another embodiment, the server interprets a meeting-setting request sentence from the user. The user enters, on the terminal, an instruction such as:
“Please schedule the next 60-minute project meeting within the next two weeks, avoiding Fridays and public holidays.”

The terminal sends this instruction to the server. The server generates a prompt sentence: “You are a scheduling assistant. The user has given the following instruction: ‘Please schedule the next 60-minute project meeting within the next two weeks, avoiding Fridays and public holidays.’ Extract structured constraints including meeting duration, start date, end date, allowed days of the week, and exclusion conditions. Return the constraints in plain text, clearly labeled.”

The server supplies this prompt sentence and the request sentence to the generative AI model, which outputs descriptions of constraint information. The server parses the descriptions and stores meeting-duration information, period information, day-of-week condition information, and exclusion condition information as structured fields. The server then recalculates common free-time information for the specified period and selects an appropriate date-and-time information for the next meeting using a combination of rule-based filtering and, in some implementations, a secondary prompt to the generative AI model as described above. The described architecture yields technical improvements to computer functioning. The server reduces storage and computation overhead by maintaining unified data structures that align character information, time information, and presentation information. Because the server uses explicit time-indexed mappings, it avoids repeated scanning of entire transcripts or videos for each user query; instead, the server accesses time segments in logarithmic or constant time using indexed queries. This enhances processing speed and reduces latency in serving segment-level playback control information.

Furthermore, the use of prompt sentences in a defined workflow allows the server to reuse a single generative AI model for multiple tasks without reconfiguration of the model itself. The server controls the behavior of the model by modifying the prompt sentences rather than by redesigning the application logic, which simplifies the software structure and reduces I/O between separate modules. The server also improves accuracy of semantic extraction because the transformer-based generative AI model, trained with sequence-level supervision and fine-tuning on meeting-specific data, can model long-range dependencies and contextual cues that rule-based parsers cannot capture. As a result, the system produces more reliable topic information, decision information, and task information, which in turn improves the quality of schedule selection and notifications.

The server's integration of deterministic interval computation with learned scoring of candidate slots provides a non-conventional scheduling mechanism. Traditional systems either rely solely on deterministic rule engines or rely solely on user judgment. In contrast, the server first computes mathematically exact common free-time information using interval arithmetic and then applies a generative AI model to evaluate human-centric criteria expressed in natural language. The server then enforces adherence to computed free-time constraints, thereby combining the strengths of symbolic and numeric computation. This hybrid approach improves scheduling precision and reduces the number of conflicts and reschedulings, which decreases network and processing loads associated with repeated calendar updates.

In additional embodiments, the server may vary internal implementations while maintaining the technical effect. The generative AI model may be configured with different numbers of layers, attention heads, and hidden dimensions depending on resource constraints. The server may implement quantization or pruning of model parameters to reduce memory usage and increase inference speed. The ASR engine may use alternative architectures, such as encoder-decoder models with attention or end-to-end transformer models, with training that minimizes word error rate using large-scale datasets of meeting audio. The schedule computation modules may use different data structures, such as balanced binary search trees, interval heaps, or segment trees, to optimize performance for particular deployment scenarios.

The terminal may be implemented as a mobile device, a desktop device, or a specialized meeting room device with integrated display and speakers. The server can adjust the format of playback control information and notification information according to the capabilities of the terminal. For example, when the terminal supports high-resolution video playback, the server can provide links that directly open a streaming session at a specified timestamp; when the terminal has limited capability, the server can provide text summaries and reduced-bandwidth audio segments.

Across these embodiments, the server does not merely automate human clerical tasks, but instead modifies the behavior of the underlying computing system by creating and maintaining specialized data structures and coordinated prompt-driven workflows. The result is a system in which the processor executes fewer redundant operations, accesses meeting data in a time-indexed and semantically indexed manner, and produces outputs that directly control media playback and communication behavior in real time. This configuration achieves measurable improvements in processing speed, data handling efficiency, and accuracy of meeting-related computations, thereby improving the functioning of the computer itself.

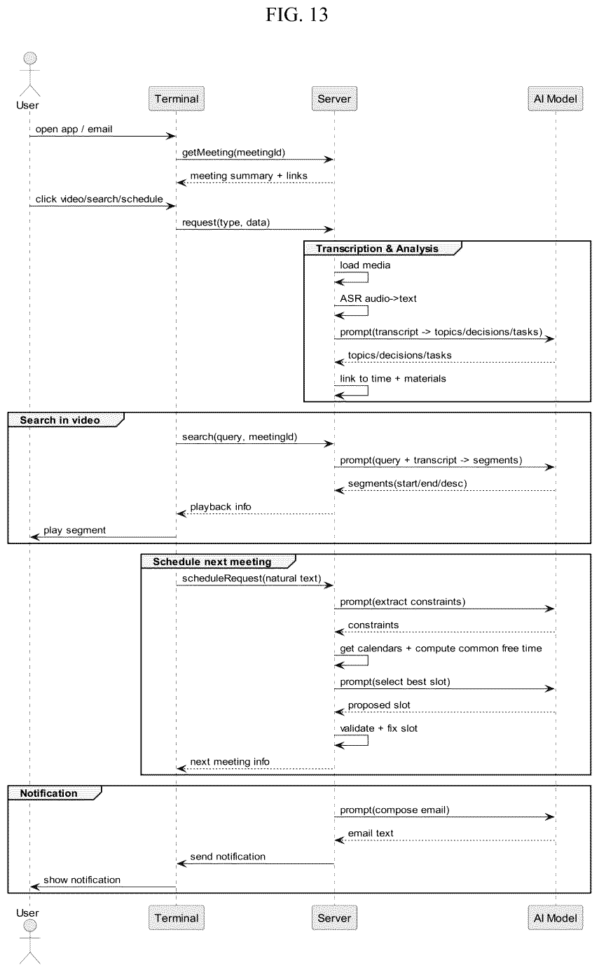

The following describes the processing flow using FIG. 13.

### Step 1:

The server acquires raw meeting media and participant metadata.

Input: raw video information and audio information of a meeting from a media capture system or storage, and participant information from a registration database.

The server receives encoded media files containing video frames and audio streams, and receives participant identifiers, communication destinations, and schedule service account identifiers. The server stores the media files in a media repository and writes meeting identifiers, file paths, and participant information into a meeting table and a participant table in a database.

Output: stored media resources linked to a meeting identifier, and database records containing meeting metadata and participant information.

### Step 2:

The server converts audio information into character information.

Input: audio information associated with a meeting identifier.

The server decodes the audio stream into a waveform, segments the waveform into frames, and applies an automatic speech recognition engine implemented as a trained neural network to produce text tokens. The server aligns recognized tokens with time positions using timestamps from the audio stream, thereby generating character information with start and end times for each utterance. The server stores this character information and time information in a transcript table.

Output: time-aligned character information stored in the database and associated with the meeting identifier.

### Step 3:

The server generates a semantic-extraction prompt sentence and invokes a generative AI model.

Input: character information for the meeting.

The server constructs a prompt sentence such as “You are a meeting analysis assistant. Given the following meeting transcript, extract (1) a list of main topics, (2) a list of decisions, and (3) a list of action items with responsible persons and due dates if mentioned. Then summarize each element in one or two sentences. Return plain text sections labeled ‘Topics:’, ‘Decisions:’, and ‘Action items:’.”

The server concatenates the prompt sentence and the character information into a single text buffer and sends this buffer as input to the generative AI model via an application programming interface. Internally, the server encodes the text as tokens and transmits the tokens to the model-hosting service.

Output: generated text from the generative AI model containing topic information, decision information, and task information in labeled sections.

### Step 4:

The server parses the model output and stores structured semantic information.

Input: generated text containing labeled topics, decisions, and action items.

The server scans the generated text to detect label markers such as “Topics:”, “Decisions:”, and “Action items:”. The server splits the text into sections and further splits each section into items based on line breaks or bullet markers. The server creates records in topic, decision, and task tables, where each record contains an item identifier, a description, and a reference to the meeting identifier. The server writes these records into the database.

Output: structured topic information, decision information, and task information stored in dedicated tables.

### Step 5:

The server associates semantic items with time information in the meeting.

Input: character information with timestamps, and structured topic, decision, and task information.

The server computes text similarity between each semantic item description and segments of the character information by using a keyword overlap or embedding-based similarity function. For each semantic item, the server identifies one or more utterances whose text is most similar to the item description. The server retrieves the start and end times of the identified utterances from the transcript table and calculates a time range for each item. The server writes these time ranges as time information fields in the records of the topic, decision, and task tables, thereby linking semantic items to specific time segments in the video information.

Output: updated semantic item records annotated with associated time information.

### Step 6:

The server links semantic items to presentation information.

Input: character information, semantic item descriptions, and a list of presentation information references.

The server identifies mentions of file names, slide titles, or document references in the character information by pattern matching. The server associates each mention with a stored resource identifier that represents a presentation material. For each semantic item, the server checks whether its description or the corresponding utterances include a recognized reference to a presentation material. When a match is found, the server stores reference information, such as a resource identifier or link, in the semantic item record.

Output: semantic item records augmented with reference information to presentation materials.

### Step 7:

The server acquires schedule information for each participant.

Input: participant information including schedule service account identifiers and stored access tokens.

The server authenticates to at least one schedule management service using access tokens and sends requests for events within a target period. The server receives schedule information in structured form, including event start times, end times, and busy status. The server converts all times to a unified time zone, creates interval objects for each busy event, and stores these intervals in schedule tables indexed by participant identifiers and meeting identifier.

Output: schedule information records representing busy intervals for each participant.

### Step 8:

The server computes free-time information and common free-time information.

Input: busy intervals for each participant and configuration of working hours.

The server defines a working hours interval set for each day in the target period. For each participant, the server subtracts the stored busy intervals from the working hours interval set by performing interval arithmetic to obtain free-time intervals. The server aggregates free-time intervals across participants by computing the intersection of intervals using an interval tree or similar data structure. The server stores the resulting common free-time information as candidate time slots for the next meeting.

Output: free-time information for each participant and common free-time information across participants.

### Step 9:

The server refines selection of the next meeting time using a generative AI model.

Input: common free-time information and constraint conditions such as desired duration, allowed days, and exclusion conditions.

The server formats the common free-time information as a human-readable list and constructs a prompt sentence such as “Here is a list of common free time slots for all participants: [slot list]. Choose the best single 60-minute slot, preferring times between 10:00 and 16:00 on weekdays and avoiding Fridays. Provide your choice and a short explanation in plain text.”

The server concatenates the prompt sentence with the slot list and sends the combined text to the generative AI model. The server receives the model's proposed date-and-time information and explanation, parses the proposed time slot, and verifies that it belongs to the previously computed common free-time information and satisfies the constraint conditions.

Output: validated date-and-time information for the next meeting and an associated explanatory message.

### Step 10:

The server generates outline information for the meeting.

Input: topic information, decision information, task information, time information, and reference information.

The server builds a hierarchical outline structure where each topic contains its associated decisions and tasks. For each node, the server attaches the corresponding time ranges and links to presentation materials. The server serializes this structure into a textual outline and stores it in an outline table.

Output: outline information representing a structured summary of the meeting.

### Step 11:

The server generates notification information using a generative AI model.

Input: outline information, date-and-time information of the next meeting, and participant information.

The server constructs a prompt sentence such as “Compose an email to the meeting participants. Include: (1) the date and time of the next meeting: [date-time], (2) a concise summary of main topics, (3) a bullet list of decisions, and (4) a bullet list of action items with responsible persons and due dates. Use a polite business tone.”

The server concatenates the prompt sentence with the outline text and supplies it to the generative AI model. The server receives a natural-language email body, inserts participant-specific salutations if needed, and combines the text with subject lines and links to presentation materials and time segments. The server writes the resulting notification information into a message queue or email sending module.

Output: finalized notification information, including email subject, body, and embedded links, ready for transmission.

### Step 12:

The server transmits notification information to terminals.

Input: notification information and participant communication destinations.

The server connects to an email transport service or messaging service and issues send commands for each participant. The server attaches the meeting outline, the next meeting date-and-time information, and URLs that include parameters for starting playback at specified time positions. The network interface of the server transmits the notification messages over the communication network to the corresponding terminals.

Output: delivered messages appearing in terminal applications of participants.

### Step 13:

The user views the notification and accesses linked resources on the terminal.

Input: received notification information on the terminal.

The user opens the message in an email client or messaging application. The terminal renders the subject, body text, and clickable links. The user selects a link that points to a time segment, a presentation material, or a search tool. The terminal interprets the link and sends an HTTP or HTTPS request to the server to retrieve additional data or to request playback control information.

Output: user-initiated requests from the terminal to the server for viewing or playback.

### Step 14:

The user inputs search-word information or a natural-language query on the terminal.

Input: user's textual input entered via a keyboard or touch interface.

The terminal displays a search field or query input field in a web page or application view. The user types a query such as “Show me the part of the meeting where the final decision on the budget was made.” The terminal packages the query together with the meeting identifier into a request message and sends it to the server via the communication network.

Output: a search request containing search-word information and meeting identifier delivered to the server.

### Step 15:

The server identifies corresponding time periods for the query using a generative AI model.

Input: search-word information, character information, and time information.

The server constructs a prompt sentence such as “Given the following meeting transcript with timestamps, and the query ‘Show me the part of the meeting where the final decision on the budget was made’, identify the three most relevant time segments. For each segment, provide the start time, the end time, and a short description.”

The server concatenates the prompt sentence, the search-word information, and the character information with embedded timestamps, and submits this text to the generative AI model. The server receives a description of candidate time segments, extracts proposed time boundaries and descriptions, and aligns the proposed times with actual utterance timestamps stored in the transcript table. The server generates playback control information for each identified time segment.

Output: a list of time segments with start and end times and descriptions, encapsulated as playback control information.

### Step 16:

The server returns playback control information to the terminal.

Input: playback control information for relevant time segments.

The server formats playback control information as a structured response containing media resource identifiers, start timestamps, end timestamps, and short descriptions. The server transmits this response to the terminal over the communication network.

Output: a response message delivered to the terminal, enabling the terminal to present segment options to the user.

### Step 17:

The terminal displays candidate segments and controls playback.

Input: playback control information received from the server.

The terminal parses the response and renders a list of segments, each with a description and a play control. When the user selects a segment, the terminal initializes a media player component, sets the media source to the specified resource identifier, seeks to the start timestamp provided in the playback control information, and begins playback. The terminal optionally stops playback at the end timestamp or allows continuous playback.

Output: playback of the selected portion of the meeting video or audio on the terminal.

### Step 18:

The user issues a meeting-setting request sentence in natural language on the terminal.

Input: user's scheduling instruction entered through the user interface.

The user types an instruction such as “Please schedule the next 60-minute meeting within the next two weeks, avoiding Fridays and holidays.” The terminal encapsulates the instruction and meeting identifier in a request and sends it to the server.

Output: a meeting-setting request sentence transmitted from the terminal to the server.

### Step 19:

The server extracts constraint information from the meeting-setting request sentence using a generative AI model.

Input: meeting-setting request sentence.

The server constructs a prompt sentence such as “You are a scheduling assistant. The user has given the following instruction: ‘Please schedule the next 60-minute meeting within the next two weeks, avoiding Fridays and holidays.’ Extract structured constraints including meeting duration, start date, end date, allowed days of the week, and exclusion conditions. Return the constraints in plain text, clearly labeled.”

The server concatenates the prompt sentence and the request sentence and sends them to the generative AI model. The server receives a textual description of constraints, parses labeled items, and writes meeting-duration information, period information, day-of-week condition information, and exclusion condition information into a constraints data structure.

Output: structured constraint information stored in the server for the meeting.

### Step 20:

The server recalculates and finalizes the next meeting schedule.

Input: constraint information and previously computed free-time information or schedule information.

The server filters common free-time information according to the period information, day-of-week condition information, and exclusion condition information. The server discards time slots shorter than the meeting-duration information and orders remaining slots by priority rules. The server may optionally send a refined list of slots to the generative AI model with a scheduling prompt, as in Step 9, and validate the recommended slot. The server selects the final date-and-time information for the next meeting, stores it in the database, and updates any related notification or calendar entries.

Output: final date-and-time information for the next meeting stored and ready for use in subsequent notifications and calendar updates.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional meeting analysis and maintenance-support systems largely treat recordings, transcripts, calendar data, and sensor data as separate silos. As a result, a processor typically performs multiple disjoint batch operations: speech recognition, basic keyword extraction, static email generation, and manual scheduling. This fragmented approach imposes several technical problems in the context of computer technology.

First, a processor that merely stores raw recordings and linear transcripts forces users to repeatedly scan large multimedia files and long text sequences. This leads to inefficient use of storage access, memory, and network bandwidth, because the same unstructured data must be retrieved and processed again and again for each new query or follow-up task. The lack of structured, time-aligned metadata prevents efficient indexing and retrieval of specific sections within large multimedia objects.

Second, conventional systems do not systematically integrate generative artificial intelligence models into the processing pipeline as controllable components. In many cases, a generative model is invoked in an ad-hoc manner, with free-form prompts manually crafted by human operators. This results in non-deterministic behavior, heterogeneous output structures, and difficulty in automatically post-processing the generated content. Consequently, the processor cannot reliably generate machine-processable meeting summaries, action recommendations, or schedule proposals that can be used as inputs to downstream algorithms, and cannot optimize resource usage by reusing such structured outputs.

Third, typical meeting systems do not tightly couple structured meeting information with external information processing services, such as calendar services and document retrieval systems, at the processor level. As a result, the processor must perform redundant lookups and heuristic matching for each new scheduling or document-retrieval request. This increases computational overhead, network traffic, and latency, and often yields sub-optimal or conflicting results when integrating participant availability and related materials.

Fourth, emotion analysis and equipment-state analysis are generally implemented as separate subsystems, if at all, and are not used to dynamically adapt how the core computation is performed. For example, conventional processors scheduling meetings do not take into account emotion patterns inferred from past meetings, and processors scheduling maintenance do not leverage generative models to unify analytical outputs and human-readable notifications. This leads to technically inefficient workflows: the processor must orchestrate multiple independent tools, and human operators must manually interpret analytic outputs and craft communications, which consumes processing resources and human intervention.

Accordingly, there is a need for improved computer-implemented techniques in which a processor: (i) converts recording information into time-aligned structured meeting information; (ii) generates and manages prompt sentences as first-class control artifacts for generative artificial intelligence models; (iii) integrates external information processing services for participant schedules and document retrieval in a coordinated manner; and (iv) combines emotion estimation and equipment-state analysis with generative processing. Such techniques should enable the processor to automatically produce machine-processable meeting support information, time-segment reference information, schedule decisions, and notification texts, thereby improving the efficiency, consistency, and scalability of the overall computing system.

The specific processing by the specific processing unit 290 of the data processing device 12 in Application Example 2 is realized by the following means.

The present invention provides a server comprising a processor configured to acquire meeting recording information, extract audio information from the meeting recording information, convert the audio information into character information, analyze the character information together with associated time information to generate structured meeting information including topic information, decision information, task information, and emotion information, generate reference information to related sections in the meeting recording information based on the structured meeting information and the time information, generate a prompt sentence for input to a generative artificial intelligence model based on the structured meeting information and the reference information, input the prompt sentence and the structured meeting information to the generative artificial intelligence model to cause the generative artificial intelligence model to generate meeting support information including summary information, action recommendation information, and next-meeting schedule candidate information, acquire schedule information from an external information processing service for participant schedule information based on the structured meeting information and the meeting support information to determine next-meeting schedule information or maintenance schedule information, acquire related material information by using an information retrieval apparatus for document information corresponding to the meeting recording information to generate reference information to the related material information, generate communication information including the meeting support information, the reference information, the next-meeting schedule information or the maintenance schedule information, and the reference information to the related material information, and transmit the communication information to a user apparatus by using a communication apparatus, and further generate, based on search request information or voice input information received from the user apparatus, reference information to corresponding sections in the meeting recording information by searching the structured meeting information and the time information and provide the reference information to the user apparatus. This enables the processor to transform unstructured meeting recordings and external state data into reusable, time-aligned structured representations and to orchestrate generative artificial intelligence processing, schedule determination, document retrieval, and targeted communication in an integrated, machine-controlled workflow, thereby improving the efficiency, determinism, and responsiveness of the computer system as a whole.

The term “meeting recording information” refers to digital data representing an occurrence of a meeting, including at least audio information and optionally video information and associated metadata such as timestamps, participant identifiers, or resource identifiers.

The term “audio information” refers to time-series data representing sound captured during a meeting, including speech of participants and optionally non-speech sounds, in any digital encoding format.

The term “character information” refers to textual data obtained by converting audio information into written form, including words, symbols, and punctuation, and optionally including alignment information that associates the textual data with points or intervals in time.

The term “time information” refers to data indicating temporal positions or intervals within the meeting recording information, such as start times, end times, and durations, that can be associated with corresponding portions of the character information or audio information. The term “structured meeting information” refers to data representing the content of a meeting in a machine-processable, organized form, including explicitly labeled elements such as topic information, decision information, task information, and emotion information, each associated with corresponding time information.

The term “topic information” refers to data describing one or more subjects or themes discussed during the meeting, including identifiers or textual representations of such subjects and optionally their associated time intervals.

The term “decision information” refers to data describing agreements, resolutions, or choices made during the meeting, including textual representations of the decisions and optionally associated responsible parties, deadlines, and time intervals.

The term “task information” refers to data describing actions to be performed after or during the meeting, including action descriptions, responsible entities, due dates, and optionally associated time intervals within the meeting at which the tasks were discussed.

The term “emotion information” refers to data representing estimated emotional states of one or more participants or groups of participants during the meeting, including emotion categories and corresponding confidence values, and optionally time intervals and participant identifiers.

The term “reference information” refers to data that enables direct access to or identification of specific portions of meeting recording information or related material information, such as hyperlinks, time-offset parameters, identifiers, or any combination thereof.

The term “prompt sentence” refers to textual control data provided as input to a generative artificial intelligence model, the textual control data specifying instructions, constraints, or context that influence how the generative artificial intelligence model processes input data and generates output data.

The term “generative artificial intelligence model” refers to an information processing component implemented by software and/or hardware that receives input data including a prompt sentence and produces output data by generating new textual or structured content based on learned statistical or machine-learning relationships.

The term “meeting support information” refers to output data derived from meeting-related inputs and generated by the processor and/or the generative artificial intelligence model, including at least summary information, action recommendation information, and next-meeting schedule candidate information.

The term “summary information” refers to data representing a condensed description of the meeting content, including key topics, important decisions, and principal tasks, expressed in a shorter and more abstract form than the original character information.

The term “action recommendation information” refers to data describing proposed actions or follow-up steps derived from meeting content, including suggested responsibilities, priorities, and timelines.

The term “next-meeting schedule candidate information” refers to data describing one or more proposed time slots or dates for a subsequent meeting, each candidate including at least a time interval and optionally additional constraints such as participant sets or resource requirements.

The term “next-meeting schedule information” refers to data indicating a selected time slot or date for a subsequent meeting, determined from candidate time slots and participant schedule information.

The term “maintenance schedule information” refers to data specifying time points or time intervals for performing maintenance operations on equipment, derived from equipment state information, operating state information, or maintenance rules.

The term “external information processing service” refers to a system external to the server that provides processing or data related to participant schedules, such as a calendar service, and that can be accessed by the processor via a communication interface.

The term “information retrieval apparatus” refers to a computing component or system that stores document information and processes search queries to return related material information based on query terms or structured conditions.

The term “document information” refers to data representing documents, presentation materials, files, or other informational resources associated with a meeting, including content, metadata, and storage or access identifiers.

The term “related material information” refers to document information or metadata that is determined to be associated with the meeting content, for example by keyword matching, linkage in the meeting recording information, or relevance ranking.

The term “communication information” refers to data prepared for delivery to a user apparatus, including one or more of meeting support information, reference information, next-meeting schedule information, maintenance schedule information, and reference information to related material information.

The term “communication apparatus” refers to hardware and/or software components that perform data transmission between the server and external devices via one or more communication networks, using protocols such as email, messaging, or web communication. The term “user apparatus” refers to an information processing device operated by a user, such as a terminal or client device, capable of receiving, displaying, and transmitting communication information, search request information, or voice input information.

The term “search request information” refers to data specifying a query from the user apparatus, including text queries, parameters, or filters that indicate desired topics, keywords, or conditions for retrieving corresponding sections in the meeting recording information.

The term “voice input information” refers to audio data representing spoken input provided by a user via the user apparatus, the audio data being used to derive search request information or commands.

The term “equipment state information acquisition apparatus” refers to a device or system that obtains operating state information from equipment, such as sensors, controllers, or gateways that collect and forward state measurements to the processor.

The term “operating state information” refers to data representing the operational condition of equipment, including metrics such as usage time, error counts, environmental measurements, or performance indicators.

The term “maintenance work content information” refers to data describing specific operations to be performed during a maintenance event, including procedures, checks, parts replacements, and safety instructions.

The term “notification text information” refers to textual data suitable for transmission to a responsible person apparatus, the textual data describing schedule information, maintenance work content information, or meeting-related information in a human-readable form.

The term “responsible person apparatus” refers to a user apparatus associated with a person or entity responsible for performing or managing maintenance work, follow-up actions, or other tasks indicated by the system.

In one embodiment, a server executes a computer program that implements the claimed system using a combination of general-purpose hardware and specialized software components. The server comprises at least one central processing unit (CPU), a main memory, a non-volatile storage device, a network interface, and optionally a graphics processing unit (GPU) for acceleration of neural-network inference. The server runs an operating system such as a general-purpose server operating system, and executes application software including a web server, an application server framework, a database management system, and various libraries for media processing, speech recognition, natural language processing, emotion analysis, search indexing, and generative artificial intelligence inference. The server uses a media processing library such as a command-line multimedia framework to handle meeting recording information. The meeting recording information is typically stored as a container file (for example, MP4 or WebM) including audio and optionally video streams. The server invokes the media processing library as a subprocess or through an application programming interface to extract audio information from the meeting recording information and to convert the audio information into an intermediate audio format such as WAV or FLAC. The server stores the resulting audio file in a designated storage area for subsequent processing.

The server uses a speech recognition engine such as a cloud-based speech-to-text application programming interface (for example, a generic cloud speech-to-text service) to convert the audio information into character information. The server segments the audio file into chunks (for example, 30- to 60-second segments), sends each chunk to the speech recognition engine via a secure network protocol, and receives recognition results containing character information together with time information (start and end timestamps for words or phrases). The server merges and normalizes these recognition results, and stores the character information and associated time information in a structured data store such as a relational database or a document database. By storing time-aligned character information, the server enables random access to portions of the meeting recording information based on textual queries without repeatedly decoding the entire multimedia file, which reduces disk I/O and network traffic when many users access different parts of the same recording.

The server analyzes the character information using natural language processing libraries such as a general-purpose NLP toolkit and a dependency parser. The server loads the character information into memory, segments the text into sentences, tokenizes the sentences, performs part-of-speech tagging, and constructs dependency parse trees. The server applies rule-based patterns over these parse trees to identify topic information, decision information, and task information. For example, the server detects syntactic patterns such as first-person plural subjects combined with future tense or modal verbs (“we will”, “we should”) and complements containing verb phrases, and classifies such sentences as candidate task information. The server further applies lexical patterns (for example, “decide”, “agree”, “conclude”) and discourse markers to identify decision information. These rule-based procedures are encoded as deterministic algorithms operating over the parse trees and token sequences, and they generate structured meeting information with explicit labels and links to time information.

The server integrates emotion information into the structured meeting information by combining multiple modalities. The server can send text segments to a text-based emotion analysis service, which returns emotion categories (for example, joy, anger, sadness, fear) and confidence scores. Additionally, when video is present, the server can periodically extract frames and submit them to a facial-expression analysis module that returns probability distributions over emotion classes. The server associates the resulting emotion labels and scores with the corresponding time intervals and, when speaker identification is available, with specific participants. The server stores these emotion attributes as part of the structured meeting information, thereby enabling algorithms to reason not only about factual content but also about affective context.

The server constructs a prompt sentence for a generative AI model based on the structured meeting information and the time information. The generative AI model is implemented, for example, as a transformer-based neural network with multiple layers of self-attention and feed-forward sublayers trained on large corpora of text. The server does not treat the generative AI model as a black box but interacts with it using explicitly defined control inputs. The server assembles the prompt sentence by concatenating instruction segments and structured content segments in a predetermined template. For example, the server generates a prompt sentence such as:
“You are an assistant that summarizes meetings. From the structured data below, extract the main topics, the decisions that were made, and the action items, and then create a concise summary in English. Structured data: [topics: . . . , decisions: . . . , tasks: . . . ].”

In another example, the server generates a prompt sentence for schedule refinement:
“Given the following available time slots for a next meeting and the information that participants prefer to avoid early morning hours, propose three optimal time slots for the next meeting, sorted by preference. Available time slots: [ . . . ].”

By encoding explicit constraints and structured content in the prompt sentence, the server constrains the behavior of the generative AI model and increases the determinism and post-processing feasibility of its outputs.

The server executes the generative AI model either locally or via a remote inference service. When executed locally, the server loads a transformer-based model whose parameters have been pre-trained and optionally fine-tuned on meeting-like text. The model comprises an embedding layer, multiple attention blocks, layer-normalization modules, and an output projection layer. During inference, the server feeds the tokenized prompt sentence and structured content into the model, which processes the sequence layer by layer to generate output tokens. The server decodes these output tokens into natural language or structured text (for example, marked lists), and then parses the result to extract summary information, action recommendation information, and next-meeting schedule candidate information.

The server can also use the generative AI model to produce maintenance-related outputs. For example, the server generates a prompt sentence such as:
“Based on the following operating logs for equipment A, including hours of operation, error counts, and vibration levels over time, recommend a date for the next preventive maintenance and describe the maintenance tasks that should be performed in clear language.”

The server includes as input a structured representation of operating state information obtained from equipment sensors and logged in a time-series database. In this way, the generative AI model is used to convert dense numerical patterns and rules into human-interpretable maintenance work content information and notification text information. The server interacts with external information processing services for participant schedules and document retrieval in a structured manner that reduces redundant processing. The server uses a calendar service application programming interface to request free/busy information for multiple participants within a predefined horizon (for example, the next two weeks). The server then executes an algorithm that constructs a discrete time grid (for example, 15-minute slots), marks each slot as available or busy for each participant, and computes scores such as the number of available participants and an emotion-based penalty (for time ranges where past emotion information indicates dissatisfaction). The server may generate a prompt sentence summarizing these scored slots:
“From the following list of time slots, each with a count of available participants and an emotion-based penalty score, choose three optimal slots that maximize availability and minimize negative emotion, and explain your choices briefly.”

The generative AI model receives the structured list and returns a short explanation and selected time slots, which the server then converts into next-meeting schedule information. This combination of deterministic scoring and generative explanation allows the server to maintain algorithmic control while exploiting the model's capacity for concise natural-language justification.

The server uses an information retrieval apparatus such as a search engine to identify related material information. The server constructs search queries from topic information, decision information, and task information, and sends the queries to the search engine, which maintains inverted indexes over document information. The server receives ranked results and selects document identifiers and access locations that it then stores as related material information. The server generates reference information such as uniform resource locators that directly access these documents. This structure enables efficient reuse across users and sessions without repeatedly recomputing relevance from raw text, thereby improving throughput and reducing query latency.

The server composes communication information that includes meeting support information, reference information to time-specific sections of the meeting recording information, next-meeting schedule information or maintenance schedule information, and reference information to related material information. The server embeds the time information into playback uniform resource locators for a streaming service, using time-offset parameters or fragment identifiers. As a result, when a user selects a particular reference, a terminal can request only the relevant portion of the media stream, reducing the amount of data transferred over the network and reducing the load on the streaming subsystem.

The server transmits the communication information to a user apparatus, such as a terminal, via a communication apparatus using protocols such as email transfer, web push, or application-specific messaging. The terminal receives the communication information, stores it locally or in a client cache, and displays it via a graphical user interface. When the user selects a reference associated with a specific time interval, the terminal forwards the corresponding uniform resource locator to a media player, which establishes a connection to the media server starting at the indicated time offset. This targeted playback avoids repeated manual fast-forwarding and reduces the need for the server to send large contiguous portions of the recording.

The terminal also enables interactive search by providing a search interface and voice input capture. The terminal captures voice input information from a microphone, encodes the audio, and either sends the audio to a speech recognition service or performs recognition locally to obtain search request information in text form. For example, the user may say “Show me where we discussed project X risks” or “Find the part about the budget approval.” The terminal forwards the resulting text query to the server. The server searches the structured meeting information and the time information for matching topic information or task information, generates corresponding reference information to the identified sections, and returns the reference information to the terminal. The terminal then displays a list of clickable segments. This architecture allows the search to operate on pre-indexed, structured data instead of raw audio or video, which results in significant reductions in computational complexity and response time as the length of the recordings increases.

The server further uses an equipment state information acquisition apparatus to obtain operating state information from machines such as robots, pumps, or other industrial equipment. The apparatus collects sensor values such as operating hours, temperatures, currents, and vibration amplitudes, and sends them to the server via a network protocol such as a publish-subscribe protocol or a representational state transfer API. The server stores these time-series values and applies rule-based checks (for example, if vibration exceeds a threshold for a predefined duration, or if operating hours exceed a maintenance interval) and statistical models (for example, moving averages, anomaly scores) to infer when maintenance should be scheduled. This processing produces maintenance schedule information, which the server combines with equipment identifiers. The server then constructs a prompt sentence such as:
“Create a maintenance notification email for equipment A with the following information: next maintenance date: [date], operating hours: [value], recent error events: [summary], and recommended checks: [list]. Write the notification in formal language suitable for a maintenance engineer.”

The generative AI model returns maintenance work content information and notification text information, which the server inserts into an electronic message and transmits to a responsible person apparatus.

In one embodiment, the server's generative AI model is trained and fine-tuned with explicit optimization objectives. The server, during training, minimizes a loss function such as a cross-entropy loss over correctly generated summary tokens and action item labels, and may use additional auxiliary losses such as sequence-level reward approximations that encourage consistent extraction of structured fields (for example, always labeling action items with responsible party and due date). The training process comprises iterating over batches of training data, computing gradients of the loss with respect to model parameters by backpropagation, and updating the parameters via an optimizer such as stochastic gradient descent with momentum or an adaptive gradient method. The server can further apply data augmentation techniques, such as paraphrasing meeting texts or randomly masking sentence components, to improve robustness. By explicitly describing this training procedure, the system ensures that the generative AI model produces outputs in a constrained, predictable structure, which can then be reliably parsed and integrated into downstream computations. The server separates the generative AI inference from deterministic preprocessing, such that the generative AI model always receives structured inputs rather than raw, noisy transcripts. This architecture reduces the search space for the model, which improves response time and reduces the energy required for inference. In addition, because the server retains and reuses structured meeting information across multiple queries and users, the system avoids repeated re-recognition or re-parsing of the same recording, unlike conventional systems that repeatedly apply full text analysis to every new query.

In another embodiment, the server implements alternative neural-network architectures or algorithms for some functions. For instance, the server can use a recurrent neural network with attention for generating summaries instead of a transformer model, or can use a convolutional network for emotion classification from spectrograms derived from audio information. The server may also replace cloud-based speech recognition with an on-premise acoustic model and language model running on the server's GPU. These alternative realizations still follow the same data flow and structured meeting information concept, and provide the same technical effects of reduced redundant processing, improved retrieval granularity, and lower communication overhead.

The server also improves data management by enforcing explicit data structures for meeting recording information, structured meeting information, and reference information. The server uses normalized tables or schema-validated documents where each row or document represents a meeting, and related tables link utterances, segments, topics, decisions, tasks, and emotion labels to time intervals and participants. Indexes are created on time information and on lexical forms of topic information and task information. When processing queries, the server utilizes these indexes to perform logarithmic-time or near-logarithmic-time lookups rather than scanning entire transcripts, which provides a concrete computational advantage over approaches that treat meeting data as unindexed text blobs.

The server and terminal, when deployed together, thus embody more than a mere automation of human note-taking or scheduling. The server's generation and use of prompt sentences as structured control inputs, the precomputation of time-aligned, labeled representations of meeting content, the integration of emotion and equipment-state analysis into schedule and notification decisions, and the use of deterministic algorithms to bound and guide generative AI outputs collectively alter how the computing system stores, indexes, and retrieves multimedia data. Because these operations reduce redundant processing, improve retrieval precision at the level of time-stamped segments, and lower network bandwidth consumption by enabling partial streaming, the system provides specific and concrete improvements to computer technology rather than an abstract idea executed on a generic computer.

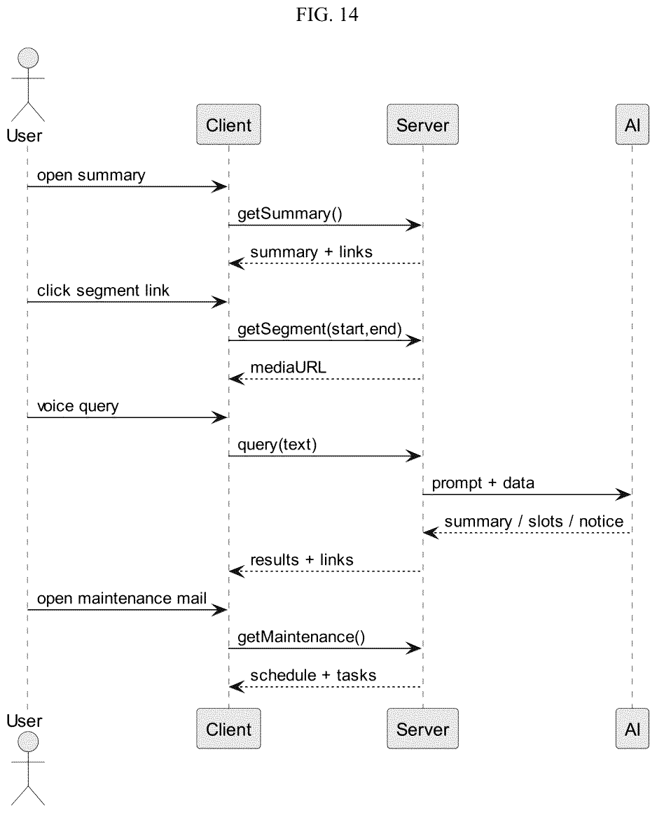

The following describes the processing flow using FIG. 14.

### Step 1:

Server acquires meeting recording information and stores it.

Server receives as input a meeting identifier and authentication information from a scheduling system or storage service. Server sends a request via a network interface to a storage service, retrieves a container file (for example, an MP4 file including audio and optionally video), and writes the binary stream to local storage. Server thereby outputs a stored meeting recording file that can be accessed by subsequent components.

### Step 2:

Server extracts audio information from the meeting recording information.

Server takes as input the stored meeting recording file from Step 1. Server invokes a media processing library through a system call, demultiplexes the container, and separates the audio stream into a standalone audio file (for example, WAV or FLAC). Server performs decoding and re-encoding operations to normalize sample rate and channel count, and outputs a normalized audio file suitable for speech recognition.

### Step 3:

Server converts the audio information into character information with time information.

Server takes as input the normalized audio file from Step 2. Server segments the audio into fixed-length chunks, sends the chunks via a network interface to a speech-to-text engine, and receives recognition results as structured data that include text and start and end timestamps. Server concatenates the recognized segments, adjusts overlapping timestamps, and stores, as output, character information and associated time information in a database.

### Step 4:

Server parses character information and generates initial linguistic annotations.

Server uses as input the character information from Step 3. Server loads the text into memory, splits the text into sentences, tokenizes into words, and applies part-of-speech tagging and dependency parsing using a natural language processing library. Server attaches token-level and sentence-level annotations to the original text and, based on the time alignment, assigns a time interval to each sentence. Server outputs annotated sentences linked with time information.

### Step 5:

Server detects topic information, decision information, and task information.

Server takes as input the annotated sentences from Step 4. Server applies rule-based patterns and keyword lists to the dependency trees and token sequences, classifying sentences into categories such as topics (“agenda items or subjects”), decisions (“we decided”, “it is agreed”), and tasks (“we will”, “someone must”). Server uses Boolean rules and pattern matching over part-of-speech tags and dependency relations to determine labels. Server outputs structured meeting information entries with fields for type (topic, decision, task), textual content, and corresponding time information.

### Step 6:

Server augments structured meeting information with emotion information.

Server uses as input the character information, the time information, and optionally video frames extracted from the meeting recording information. Server sends text segments to an emotion analysis engine and, if video is available, sends representative frames to a facial-expression analysis engine. Server receives emotion categories and confidence scores, and then aligns these values with time intervals and, when possible, participant identifiers. Server merges these emotion attributes into the structured meeting information entries and outputs an enriched structured meeting information set including topic, decision, task, and emotion information.

### Step 7:

Server generates reference information to related sections in the meeting recording information.

Server takes as input the enriched structured meeting information and the time information. Server computes for each structured entry a start time and end time within the recording, using the sentence-level timestamps, and applies smoothing rules to avoid excessively short or overlapping segments. Server constructs uniform resource locators or player parameters that encode the meeting identifier and the time offsets. Server outputs reference information that allows direct access to specific time ranges in the meeting recording information.

### Step 8:

Server constructs a prompt sentence for a generative AI model.

Server uses as input the enriched structured meeting information and the reference information from Step 7. Server selects representative topics, decisions, and tasks, formats them into a structured text block, and inserts them into a pre-defined template to form a prompt sentence. For example, server generates:
“You are an assistant that summarizes meetings. From the structured data below, extract the main topics, the decisions that were made, and the action items, and then create a concise summary in English. Structured data: [topics: . . . , decisions: . . . , tasks: . . . , emotions: . . . ].” Server outputs the constructed prompt sentence and associated structured data prepared for input to the generative AI model.

### Step 9:

Server invokes the generative AI model using the prompt sentence.

Server takes as input the prompt sentence and the structured meeting information from Step 8. Server tokenizes the input text, sends the tokens to a transformer-based generative AI model running locally or on a remote inference service, and sets inference parameters such as maximum output length and sampling temperature. Server receives as output generated text that includes summary information, action recommendation information, and optionally formatted lists. Server parses this generated text to extract fields into structured meeting support information and stores the resulting data.

### Step 10:

Server generates next-meeting schedule candidate information using calendar data.

Server uses as input the structured meeting information, the meeting support information, and a list of participant identifiers. Server queries an external calendar service for free/busy slots within a future time window, receives time-interval data for each participant, and constructs a common time grid. Server runs a scheduling algorithm that marks each interval with the number of available participants and, optionally, an emotion-based score derived from past emotion information for similar time ranges. Server may optionally build a prompt sentence such as:
“Given the following available time slots for the next meeting, each with a count of available participants and an emotion penalty score, choose three optimal time slots that maximize availability and minimize negative emotion.”

Server inputs this prompt sentence and the scored slots to the generative AI model, receives selected candidate time slots, and outputs next-meeting schedule candidate information.

### Step 11:

Server determines next-meeting schedule information or maintenance schedule information.

Server takes as input the next-meeting schedule candidate information from Step 10 and any policy constraints. Server either directly selects the highest-ranked candidate or applies additional deterministic rules (for example, avoiding weekends or holidays) to finalize a time slot. For maintenance, server uses operating state information from equipment sensors, applies threshold and statistical rules to compute an optimal maintenance date, and outputs next-meeting schedule information or maintenance schedule information as specific calendar entries with time intervals.

### Step 12:

Server acquires related material information and generates reference information to documents.

Server uses as input the character information and the structured meeting information. Server detects explicit uniform resource locators in the text using regular expressions and also generates search queries by combining topic and task keywords. Server sends these queries to an information retrieval apparatus, receives document identifiers and relevance scores, and selects top results as related material information. Server constructs reference information (for example, document access uniform resource locators) for each selected item and outputs a list of related material information with corresponding reference information.

### Step 13:

Server composes communication information for distribution.

Server takes as input the meeting support information, the reference information to time-specific sections, the next-meeting schedule information or maintenance schedule information, and the reference information to related material information. Server populates a message template with the summary, lists of decisions and tasks, segment links, schedule details, and document links. Server formats this data into a communication structure (for example, an email body text or message payload) and outputs communication information ready for transmission.

### Step 14:

Server transmits communication information to a user apparatus.

Server uses as input the communication information from Step 13 and destination addresses associated with user apparatuses. Server connects to a communication apparatus such as an email server or messaging gateway, sends formatted messages using network protocols, and receives status responses. Server outputs confirmation that the communication information has been delivered or queued to the user apparatuses.

### Step 15:

User receives and reviews meeting support information.

User uses a terminal as input device to access an inbox or application interface. User opens the message sent in Step 14, reads the summary information, decisions, tasks, and schedule details, and views the list of reference information and related material information. User's review results in an understanding of the meeting without replaying the entire recording, and the terminal outputs visual and, when chosen, audio presentation of the information.

### Step 16:

User selects reference information to play specific sections of the meeting recording.

User takes as input the displayed links to time-specific sections on the terminal. User clicks or taps a reference, and the terminal sends the associated uniform resource locator to a media player. Terminal then receives the media stream from a server and instructs the player to begin playback at the encoded start time. Terminal outputs the audio and video of the selected section, allowing the user to access only the relevant portion.

### Step 17:

User issues a search request or voice input for targeted retrieval.

User provides as input a text query in a search field or a spoken phrase captured by a microphone on the terminal, such as “Show me where we discussed project X risks.” Terminal converts voice input into text using a speech recognition engine and outputs search request information. Terminal sends this search request information to the server via a network interface.

### Step 18:

Server searches structured meeting information based on search request information.

Server uses as input the search request information from Step 17 and the stored structured meeting information with time information. Server parses the query, extracts keywords and intent (for example, topics or tasks), and performs lookups in indexed structures that map tokens and labels to time intervals. Server identifies all structured entries that match the query conditions and compiles a result list containing textual excerpts and associated reference information to the corresponding sections of the meeting recording information. Server outputs this result list to the terminal.

### Step 19:

Terminal displays search results and enables direct navigation.

Terminal uses as input the result list from Step 18. Terminal renders a list of entries showing short excerpts, timestamps, and clickable links. When the user selects an entry, terminal sends the associated reference information to the media player and starts playback at the indicated time. Terminal outputs the audio-visual content of the selected segment, thereby satisfying the user's search request.

### Step 20:

Server processes equipment operating state information for maintenance scheduling.

Server takes as input operating state information from an equipment state information acquisition apparatus, including metrics such as runtime hours, error codes, and vibration values. Server applies rule-based checks and statistical analyses, such as computing moving averages and comparing values to predetermined thresholds, to determine whether maintenance is due or should be advanced. Server outputs maintenance schedule information including recommended dates and associated equipment identifiers.

### Step 21:

Server generates maintenance notification text using a generative AI model.

Server uses as input the maintenance schedule information from Step 20 and summarized operating state information. Server constructs a prompt sentence such as:
“Create a maintenance notification email for equipment A with the following information: next maintenance date, current operating hours, recent error events, and recommended inspection items. Write the notification in formal language for a maintenance engineer.” Server submits this prompt sentence and the structured maintenance data to the generative AI model, receives maintenance work content information and notification text information, and outputs formatted text ready for communication.

### Step 22:

Server transmits maintenance notifications to a responsible person apparatus.

Server takes as input the notification text information from Step 21 and address information for responsible personnel. Server uses the communication apparatus to send messages containing maintenance schedule information and maintenance work content information. Server outputs delivery confirmations and stores a log of notifications sent.

### Step 23:

User at the responsible person apparatus confirms and executes maintenance or follow-up actions.

User receives as input the maintenance notification or meeting follow-up communication on a terminal. User reviews the recommended maintenance date and tasks or meeting action items, updates internal scheduling or work-order systems as necessary, and may trigger additional commands to the server (for example, to mark tasks as completed). Terminal outputs updated status views and optionally sends status updates back to the server for record keeping.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

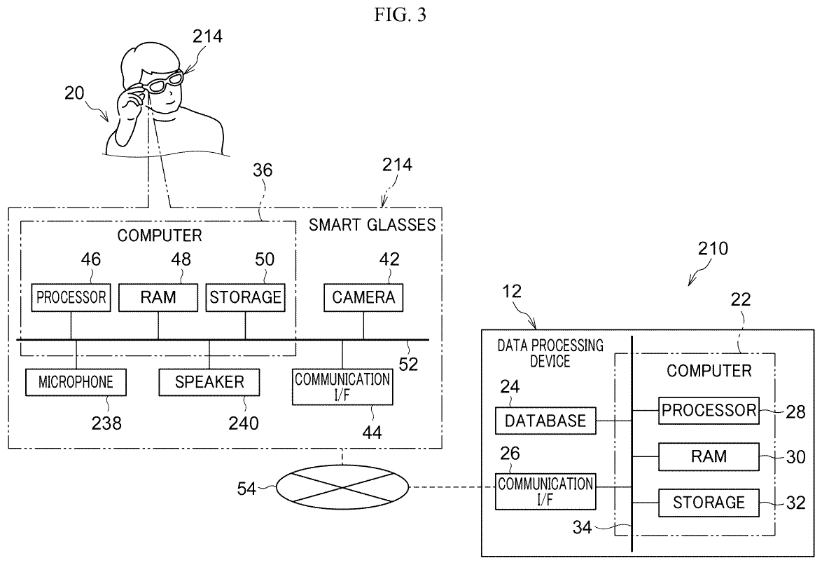

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

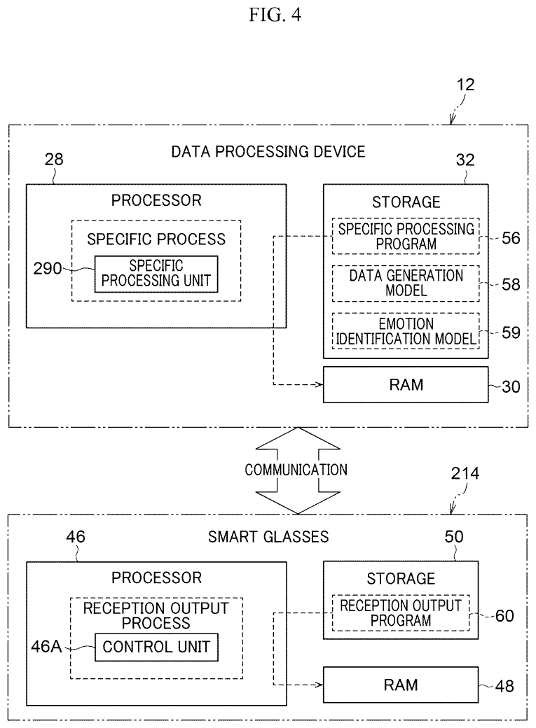

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

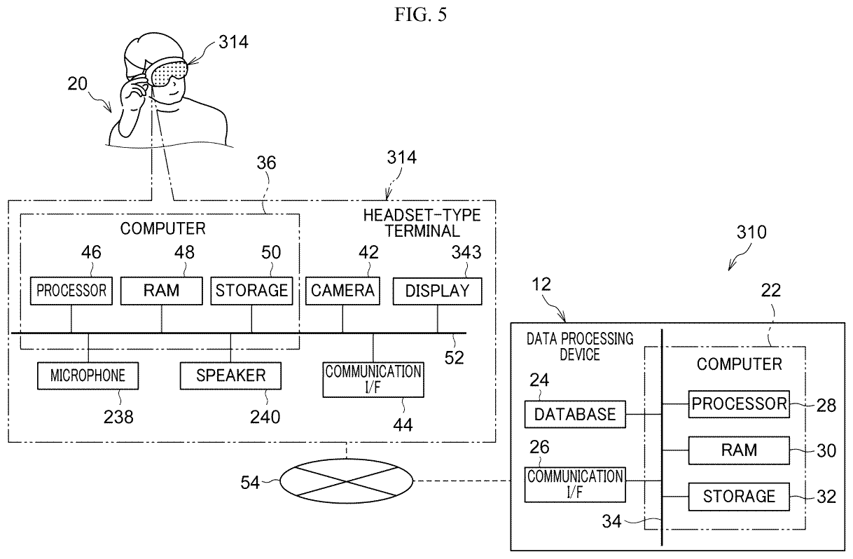

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

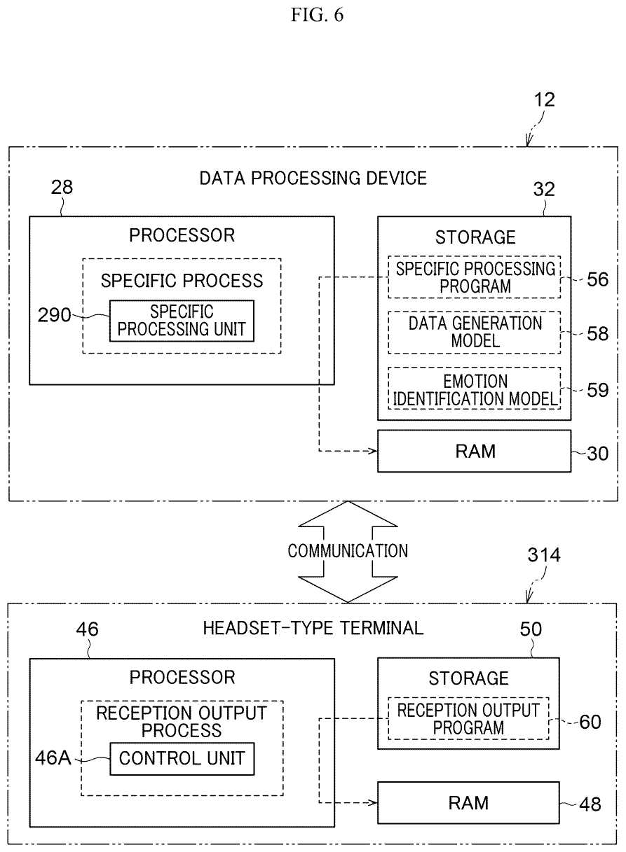

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

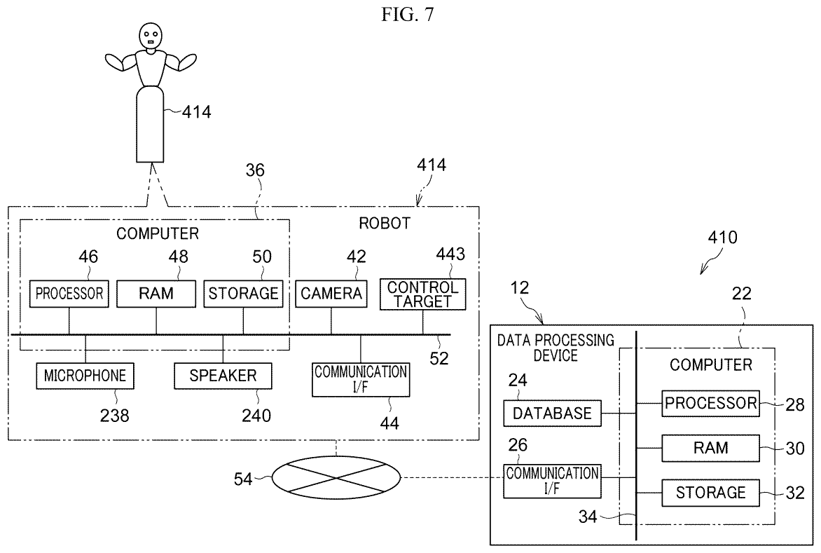

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

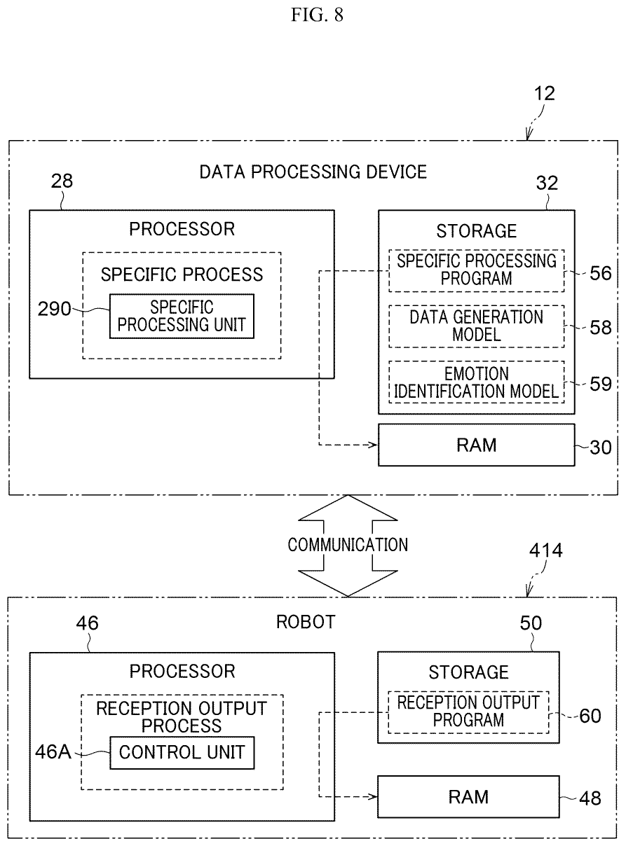

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

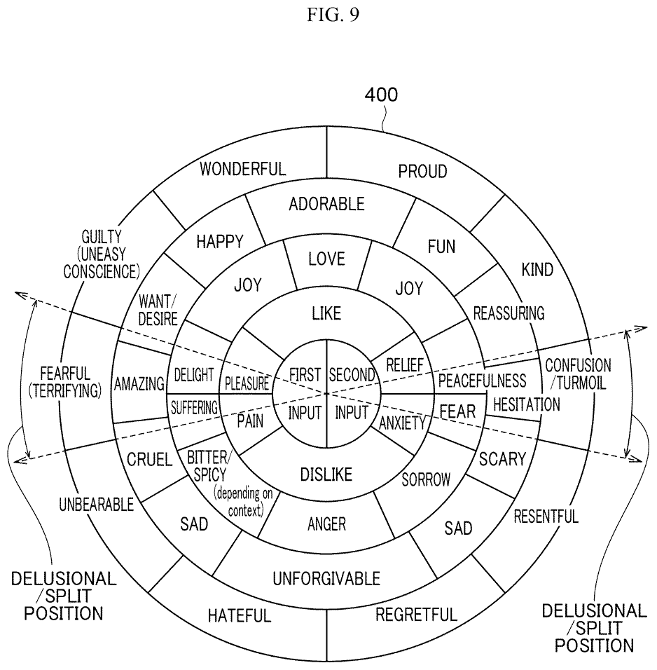

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

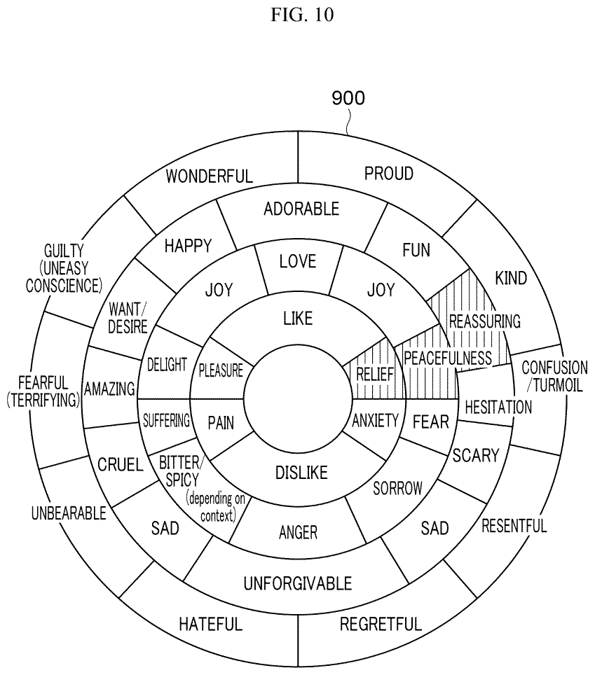

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, based on meeting identification information, meeting recording data from an external storage device via a communication network, extract an audio signal from the acquired recording data, transmit the audio signal to a speech recognition processing apparatus or an external speech recognition service, and store text data obtained as a result of speech recognition processing on the audio signal,
generate, based on the text data, a prompt sentence for causing a generative AI model implemented by a machine learning processing apparatus or an external machine learning service to extract meeting topics, decisions, and action items, input to the generative AI model input data including the prompt sentence and the text data, and store, as structured data, extraction information output from the generative AI model,
generate, based on at least one of the text data and the extraction information, a prompt sentence for causing the generative AI model to generate summary information of an entire meeting, and store the summary information in association with link information indicating identification information or location information corresponding to documents or materials shared during the meeting,
manage the link information in association with at least one of the meeting recording data and minutes information, store in association time information of the meeting recording data and utterance units of the text data, and thereby enable identification of a video time range of the recording data corresponding to a section of the text data that matches a search term, and generate notification information to be transmitted to participant terminals via an electronic communication service based on the summary information, the extraction information, and the link information, and transmit the notification information to the participant terminals.

### Supplementary 2

The system according to supplementary 1,
wherein the processor is configured to
generate minutes document data and action item list data based on the extraction information and the summary information, and automatically create the notification information including the minutes document data and the action item list data and transmit the notification information to the participant terminals via the electronic communication service so as to automatically execute a minutes creation process and a communication transmission process.

### Supplementary 3

The system according to supplementary 1,
wherein the processor is configured to
perform a search process on at least one of the text data and the extraction information in response to a search request including a search term received from a user terminal, identify a video time range of the recording data corresponding to a section of the text data obtained as a search result, and transmit to the user terminal information indicating the video time range so as to enable the user terminal to perform playback operation specifying the video time range.

### Application Example 1

### Supplementary 1

A system comprising a processor,
wherein the processor is configured to acquire meeting-related recording information via a communication line, extract acoustic information from the acquired recording information, and convert the acoustic information into character information,
wherein the processor is configured to perform syntactic analysis and semantic analysis on the character information by using a language analysis program, to extract candidate information including topic information, decision information, and action information, and to generate a prompt sentence that instructs a generative information processing model to execute summarization processing and information structuring processing, the prompt sentence being generated by using the candidate information and at least a part of the character information as input conditions,
wherein the processor is configured to input the prompt sentence to the generative information processing model, to cause the generative information processing model to generate the topic information, the decision information, and the action information in the meeting as hierarchical summary information based on the candidate information, to extract location information of material information based on reference identifiers included in the recording information or the character information, and to generate association information by associating the summary information with the location information,
wherein the processor is configured to sequentially transmit the summary information and the association information to a display terminal in a state in which updates are possible during progress of the meeting, and to cause the display terminal to visually present the summary information and the association information, and
wherein the processor is configured to transmit, after the meeting has ended, notification information including the summary information and the association information to an information terminal, and to enable the notification information to be browsed on the information terminal.

### Supplementary 2

The system according to supplementary 1,
wherein the processor is configured to use a wearable display device as the display terminal, and to cause the wearable display device to perform superimposed display of the sequentially transmitted summary information in synchronization with progress of the meeting, so that a user can refer to the topic information, the decision information, and the action information in real time while participating in the meeting.

### (Supplementary 3)

The system according to supplementary 1,
wherein the processor is configured to use a portable information processing device as the information terminal, and to output the action information included in the notification information in a format linkable to an external schedule management program or task management program, thereby supporting an operation of the user for registration of a schedule or registration of a task.

### Example 2

### Supplementary 1

A system comprising a processor,
wherein the processor is configured to
acquire video information and audio information of a meeting and convert the audio information into character information,
generate a prompt sentence based on the character information, the prompt sentence instructing a generative information processing model to extract topic information, decision information, and task information of the meeting from the character information, to summarize an extraction result, and to associate the extraction result with reference information to presentation information used in the meeting and with time information in the video information, and input the generated prompt sentence to the generative information processing model so as to cause the generative information processing model to execute the extraction, the summarization, and the association,
calculate free-time information of each participant based on participant information of the meeting and schedule information acquired from a schedule management service associated with the participant information, and specify common free-time information shared by a plurality of participants,
generate a prompt sentence based on the specified common free-time information and predetermined constraint conditions, the prompt sentence instructing the generative information processing model to determine date-and-time information of a next meeting, and input the generated prompt sentence to the generative information processing model so as to cause the generative information processing model to determine the date-and-time information of the next meeting,
generate outline information of the meeting and notification information based on the determined date-and-time information of the next meeting, the topic information, the decision information, the task information, the reference information to the presentation information, and the time information, and transmit the notification information to a terminal device via a communication network, and
receive search-word information input at the terminal device, generate a prompt sentence based on the search-word information, the character information, and the time information, the prompt sentence instructing the generative information processing model to specify a corresponding time period in the video information, input the generated prompt sentence to the generative information processing model so as to cause the generative information processing model to specify the corresponding time period, and provide playback control information of the corresponding time period to the terminal device.

### Supplementary 2

The system according to supplementary 1,
wherein the processor is configured to
generate a prompt sentence based on the character information, the topic information, the decision information, and the task information, the prompt sentence instructing the generative information processing model to automatically generate minutes information and message information, input the generated prompt sentence to the generative information processing model so as to cause the generative information processing model to create the minutes information and the message information, and transmit the message information to communication destinations corresponding to the participant information.

### Supplementary 3

The system according to supplementary 1,
wherein the processor is configured to
acquire a meeting-setting request sentence expressed in natural language from the terminal device, generate a prompt sentence instructing the generative information processing model to extract constraint information including meeting-duration information, period information, day-of-week condition information, and exclusion condition information from the meeting-setting request sentence, input the generated prompt sentence to the generative information processing model so as to cause the generative information processing model to output the constraint information, and calculate the date-and-time information of the next meeting based on the constraint information and the common free-time information.

### Application Example 2

### Supplementary 1

A system comprising a processor,
wherein the processor is configured to
acquire meeting recording information, extract audio information from the meeting recording information, and convert the audio information into character information,
analyze the character information and time information associated with the character information to generate structured meeting information including topic information, decision information, task information, and emotion information, and generate reference information to related sections in the meeting recording information by using the structured meeting information and the time information,
generate a prompt sentence for input to a generative artificial intelligence model based on the structured meeting information and the reference information, input the prompt sentence and the structured meeting information to the generative artificial intelligence model, and cause the generative artificial intelligence model to generate meeting support information including summary information, action recommendation information, and next-meeting schedule candidate information,
acquire schedule information from an external information processing service for acquiring participant schedule information based on the structured meeting information and the meeting support information, and determine next-meeting schedule information or maintenance schedule information,
acquire related material information by using an information retrieval apparatus for document information retrieval corresponding to the meeting recording information, and generate reference information to the related material information,
generate communication information including the meeting support information, the reference information, the next-meeting schedule information or the maintenance schedule information, and the reference information to the related material information, and transmit the communication information to a user apparatus by using a communication apparatus, and generate, based on search request information or voice input information received from the user apparatus, reference information to corresponding sections in the meeting recording information by searching the structured meeting information and the time information, and provide the reference information to the user apparatus.

### Supplementary 2

The system according to supplementary 1,
wherein the processor is configured to use an emotion estimation processing apparatus to estimate participant emotion information from the meeting recording information and the character information, and to reflect the emotion information in the structured meeting information and in determination of the next-meeting schedule information by instructing and causing the generative artificial intelligence model to perform processing through the prompt sentence input to the generative artificial intelligence model.

### Supplementary 3

The system according to supplementary 1,
wherein the processor is configured to analyze operating state information acquired from an equipment state information acquisition apparatus, determine the maintenance schedule information based on the operating state information, input a prompt sentence including the maintenance schedule information and equipment identification information to the generative artificial intelligence model to cause the generative artificial intelligence model to generate maintenance work content information and notification text information, and transmit the notification text information to a responsible person apparatus by using the communication apparatus.

What is claimed is:

1. A system comprising:
circuitry configured to:
acquire, based on session identification information, recording data from an external storage device via a communication interface coupled to a packet-switched network, extract an audio signal from the recording data, and transmit the audio signal to a speech recognition processing apparatus to obtain text data;
generate a first prompt sentence based on the text data and input the first prompt sentence together with the text data to a generative neural network model to extract topic data, decision data, and action item data, and store the extracted data as structured records;
generate a second prompt sentence based on at least one of the text data and the structured records and input the second prompt sentence to the generative neural network model to generate summary information, and store the summary information in association with link information indicating location information corresponding to documents shared during the session;
associate time information of the recording data with utterance units of the text data in a time-indexed transcript, enabling identification of a recording data time range corresponding to a text segment matching a search term; and
generate notification information based on the summary information, the structured records, and the link information, and transmit the notification information to participant terminal devices via the communication interface.

2. The system of claim 1, wherein the circuitry is configured to extract the audio signal by demultiplexing audio and video streams from the recording data using a media format parser, and to transmit the audio signal to the speech recognition processing apparatus as a packetized audio stream with associated session identification information.

3. The system of claim 2, wherein the circuitry is configured to receive the text data from the speech recognition processing apparatus as a sequence of timestamped utterance units, each comprising a speaker identifier, a start time offset, an end time offset, and recognized text tokens.

4. The system of claim 3, wherein the circuitry is configured to construct the time-indexed transcript by storing the timestamped utterance units as records in a storage device indexed by the start time offset, and to resolve a text segment matching a search term by performing a substring search and retrieving the corresponding time offset range from the index.

5. The system of claim 4, wherein the link information is associated with the time-indexed transcript at the time offset at which a corresponding document was shared, enabling retrieval of the shared document link from any time-aligned text segment.

6. The system of claim 1, wherein the first prompt sentence is generated by constructing an instruction section specifying extraction targets comprising the topic data, the decision data, and the action item data, and a content section embedding the text data, and the circuitry is configured to parse model output tokens to map extracted items to structured record fields.

7. The system of claim 6, wherein the structured records comprise separate record types for topic records, decision records, and action item records, each linked by a session identifier and an associated time offset range from the time-indexed transcript.

8. The system of claim 7, wherein the circuitry is configured to resolve the action item records to responsible participant identifiers by cross-referencing speaker identifier fields in the utterance units with a participant registry stored in the storage device.

9. The system of claim 1, wherein the second prompt sentence is generated by concatenating a summarization instruction section with a selection of the text data and key items from the structured records, and applying a token budget constraint to limit total input length to the generative neural network model.

10. The system of claim 9, wherein the circuitry is configured to apply an extractive pre-selection step before generating the second prompt sentence by scoring utterance units using term frequency-inverse document frequency weighting and selecting a subset of highest-scoring utterance units for inclusion in the second prompt sentence.

11. The system of claim 1, wherein the notification information comprises a session summary section derived from the summary information, an action item list section derived from the action item records, and a reference section comprising the link information formatted as navigable links.

12. The system of claim 11, wherein the circuitry is configured to personalize the notification information per participant by filtering action item records by responsible participant identifier and including only records attributed to the recipient participant in the action item list section.

13. The system of claim 12, wherein the notification information is transmitted via an electronic message service, and the circuitry is configured to format the notification information as structured electronic messages with embedded hyperlinks corresponding to the link information.

14. The system of claim 1, wherein the circuitry is configured to receive a search query from a terminal device via the communication interface, execute a text search against the time-indexed transcript, and return a search result comprising matched text segments and corresponding recording data time ranges to the terminal device.

15. The system of claim 14, wherein the circuitry is configured to generate playback control information from the recording data time range and transmit the playback control information to the terminal device to initiate playback of the recording data at the matched time offset.

16. The system of claim 1, wherein the circuitry is configured to generate a follow-up prompt sentence incorporating the structured records from a prior session and current session structured records, input the follow-up prompt sentence to the generative neural network model, and extract cross-session continuity information indicating action items carried over from the prior session.

17. The system of claim 1, wherein the circuitry is configured to score the summary information using a coherence metric computed by the generative neural network model and regenerate the summary information with an adjusted prompt sentence when the coherence metric falls below a minimum coherence threshold.

18. A system comprising:
circuitry configured to:
acquire, based on session identification information, recording data from an external storage device via a communication interface coupled to a packet-switched network, demultiplex audio streams from the recording data, and transmit the audio streams to a speech recognition processing apparatus to obtain timestamped utterance units comprising speaker identifiers, start time offsets, end time offsets, and recognized text tokens;
construct a time-indexed transcript by indexing the timestamped utterance units by start time offset, generate a first prompt sentence with an extraction instruction section and a text data content section, and input the first prompt sentence to a generative neural network model to extract topic records, decision records, and action item records, each linked by a session identifier and a time offset range;
apply extractive pre-selection by scoring utterance units with term frequency-inverse document frequency weighting, generate a second prompt sentence with a token budget constraint from selected utterance units and key structured records, and input the second prompt sentence to the generative neural network model to produce summary information stored with associated link information;
resolve action item records to responsible participant identifiers by cross-referencing speaker identifier fields with a participant registry, and personalize notification information per participant by filtering action item records by responsible participant identifier; and
transmit personalized notification information comprising summary sections, filtered action item list sections, and reference sections with formatted link information to participant terminal devices via the communication interface.

19. The system of claim 18, wherein the circuitry is configured to receive a search query from a terminal device via the communication interface, execute a substring search against the time-indexed transcript, and transmit search results comprising matched text segments and corresponding recording data time ranges together with playback control information to the terminal device.

20. A method comprising:
acquiring, based on session identification information, recording data from an external storage device via a communication interface coupled to a packet-switched network, extracting an audio signal, and transmitting the audio signal to a speech recognition processing apparatus to obtain text data;
generating a first prompt sentence and inputting the first prompt sentence together with the text data to a generative neural network model to extract topic data, decision data, and action item data as structured records;
generating a second prompt sentence and inputting the second prompt sentence to the generative neural network model to generate summary information stored in association with link information;
associating time information of the recording data with utterance units of the text data in a time-indexed transcript; and
generating notification information based on the summary information, the structured records, and the link information and transmitting the notification information to participant terminal devices via the communication interface.
